(19) United States
(12) Patent Application Publication
(10) Pub. No.: US 2023/0406991 A1
(43) Pub. Date: Dec. 21, 2023

(54) THIXOTROPIC DIUREA-DIURETHANE COMPOSITION

(71) Applicant: Arkema France, Colombes (FR)

(72) Inventors: Dmitri COLESNIC, Paris (FR); Vincent LEROY, Verneuil En Halatte (FR); Thierry SOULA, Verneuil En Halatte (FR); Virginie DUCASTEL, Verneuil En Halatte (FR); Sylvain BEAUDRAIS, Verneuil En Halatte (FR)

(21) Appl. No.: 18/038,239

(22) PCT Filed: Dec. 6, 2021
(86) PCT No.: PCT/EP2021/084323

§ 371 Date: May 23, 2023

(30) Foreign Application Priority Data
Dec. 7, 2020 (FR) FR.2012756

(51) Int. Cl. C08G 18/38; C08G 18/10; C08K 5/21

(52) U.S. Cl. CPC C08G 18/3819; C08G 18/10; C08K 5/21

(57) ABSTRACT

The present invention relates to a thixotropic composition comprising a diurea-diurethane compound and an aprotic solvent, to its process of preparation and also to its use as rheology agent, in particular as thixotropic agent, especially in a binder composition.

### TECHNICAL FIELD

The present invention relates to a thixotropic composition comprising one or more diurea-diurethane compounds and an aprotic solvent, to its process of preparation and also to its use as rheology agent, in particular as thixotropic agent, especially in a binder composition.

### PRIOR ART

Diurea-diurethane compounds are already known as organogelator agents, that is to say small organic molecules capable of gelling all kinds of organic solvents, even at relatively low concentrations by weight (less than 1% by weight), or as rheology additives, that is to say additives which make it possible to modify the rheology of an applicational formulation. They make it possible to obtain, for example, a thixotropic or pseudoplastic effect.

Thixotropic agents in the liquid form are particularly valued since they can be easily incorporated in a formulation, in particular an aqueous coating formulation.

U.S. Pat. No. 4,314,924 describes a thixotropic composition comprising a solution of diurea-diurethane in an aprotic solvent and from 0.1 to 2 mol of LiCl per urea group. The LiCl is used to stabilize the composition. However, the presence of this lithium salt can cause problems of corrosion when the composition is applied to metal substrates and can generate uncontrolled entities due to its Lewis acidity. Furthermore, lithium salts, in particular LiCl, are toxic compounds and the formulations which contain them are subject to the regulations in force as regards classification, labelling and packaging of chemicals.

The composition is prepared by reacting 1 mol of a monoalcohol with 1 mol of a diisocyanate in order to form a monoisocyanate adduct, which is subsequently introduced into an aprotic solvent containing 0.5 mol of a polyamine and from 0.1 to 2 mol of LiCl. However, the structure of the diurea-diurethane compound is not perfectly controlled as a result of the use of a stoichiometric ratio between the monoalcohol and the diisocyanate. This can generate unreactive or insoluble entities which will have a tendency to precipitate.

U.S. Pat. No. 6,420,466 describes a process for the preparation of a thixotropic agent containing diurea-diurethane compounds by reacting a monoalcohol with an excess of toluene diisocyanate in order to form a monoisocyanate adduct. The excess toluene diisocyanate is subsequently removed by distillation at reduced pressure and the monoisocyanate adduct then reacts with a diamine in an aprotic solvent in the presence of LiCl. This process also uses a corrosive lithium salt and the stage of distillation of the excess diisocyanate is expensive and requires specific plants on the industrial scale.

There thus exists a need for a novel liquid thixotropic additive based on diurea-diurethane which is stable even in the absence of lithium salt, which can be easily prepared without a stage of distillation of residual diisocyanate and which has rheological performance qualities at least equivalent to, indeed even better than, those of the comparable additives of the prior art.

After numerous research studies, the Applicant Company has developed a thixotropic composition which meets this need.

### SUMMARY OF THE INVENTION

The invention relates to a thixotropic composition comprising a compound of formula (I) or a mixture of compounds of formula (I) and an aprotic solvent:

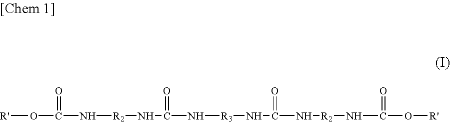

R′, R₂ and R₃ being as defined below;
the composition containing less than 0.1 mol of salt per urea group in the composition, aprotic solvent excluded.

Another subject-matter of the invention is a process for the preparation of a thixotropic composition comprising the following stages:
a) reacting at least one diisocyanate of formula OCN—R₂—NCO with at least one alcohol of formula R′—OH in order to form at least one monoisocyanate adduct of formula R′—O—C(═O)—NH—R₂—NCO, the molar ratio of the total amount of alcohol to the total amount of diisocyanate ranging from 1.10 to 1.80, in particular from 1.20 to 1.60, more particularly from 1.25 to 1.45, more particularly still from 1.30 to 1.40;
b) reacting the at least one monoisocyanate adduct obtained in stage a) with at least one diamine of formula H₂N—R₃—NH₂ in the presence of less than 0.2 mol of metal salt per mole of diamine used, in order to form at least one compound of formula (I)

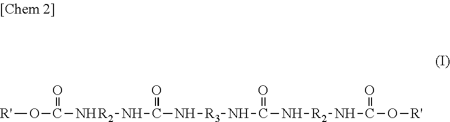

R′, R₂ and R₃ being as defined below.

Another subject-matter of the invention is a binder composition comprising a binder and the thixotropic composition according to the invention or prepared according to the process of the invention.

Another subject-matter of the invention is the use of the thixotropic composition according to the invention or prepared according to the process of the invention as rheology agent, in particular as thixotropic agent.

### DETAILED DESCRIPTION

### Definitions

In the present patent application, the terms “comprises a” and “comprises an” mean “comprises one or more”.

Unless otherwise mentioned, the percentages by weight in a compound or a composition are expressed with respect to the weight of the compound or of the composition.

The term “diurea-diurethane compound” means a compound having two urea functional groups and two urethane functional groups.

The term “diurethane compound” means a compound having two urethane functional groups and no urea functional group.

The term “polyurea-diurethane compound” means a compound having two urethane functional groups and at least four urea functional groups.

The term “urea functional group” or “urea group” means an —NH—C(═O)—NH— sequence.

The term “urethane functional group” or “urethane group” means an —NH—C(═O)—O— or —O—C(═O)—NH— sequence.

The term “solvent” means a liquid having the property of dissolving, diluting or lowering the viscosity of other substances without chemically modifying them and without itself being modified.

The term “aprotic solvent” means a solvent which does not have an acidic hydrogen atom. In particular, an aprotic solvent does not comprise a hydrogen atom bonded to a heteroatom (O, N or S).

The term “salt” means an ionic compound. A salt can be inorganic or organic, preferably inorganic. Within the meaning of the present invention, the term “salt” does not include ionic surfactants.

The term “surfactant” means a compound capable of modifying the surface tension between two surfaces. A surfactant can in particular be an amphiphilic compound, that is to say that it exhibits two parts of different polarity, the lipophilic one (which retains fatty substances) is non-polar and the other hydrophilic one (water-miscible) is polar.

The term “alkyl” means a saturated monovalent acyclic group of formula —CₙH₂ₙ₊₁. An alkyl can be linear or branched. A C₁-C₃₀ alkyl means an alkyl having from 1 to 30 carbon atoms.

The term “alkenyl” means a monovalent acyclic hydrocarbon group having one or more C═C double bonds. An alkenyl can be linear or branched. A C₂-C₃₀ alkenyl means an alkenyl having from 2 to 30 carbon atoms.

The term “cycloalkyl” means a monovalent cyclic hydrocarbon group. A cycloalkyl can be saturated or unsaturated. A cycloalkyl is non-aromatic. A C₅-C₁₂ cycloalkyl means a cycloalkyl having from 5 to 12 carbon atoms.

The term “aryl” means a monovalent aromatic hydrocarbon group. A C₆-C₁₂ aryl means an aryl having from 6 to 12 carbon atoms.

The term “arylalkyl” means an alkyl group substituted by an aryl group.

The term “aliphatic” means a non-aromatic acyclic compound or group. It can be linear or branched, saturated or unsaturated and substituted or unsubstituted. It can comprise one or more bonds/functional groups, for example chosen from ether, ester, amine and their mixtures.

The term “cycloaliphatic” means a non-aromatic compound or group comprising a ring having only carbon atoms as ring atoms. It can be substituted or unsubstituted.

The term “aromatic” means a compound or a group comprising an aromatic ring, that is to say obeying Hückel's rule of aromaticity, in particular a compound comprising a phenyl group. It can be substituted or unsubstituted. It can comprise one or more bonds/functional groups as defined for the term “aliphatic”.

The term “araliphatic” means a compound or a group comprising an aliphatic part and an aromatic part.

The term “heterocyclic” means a compound or a group comprising a ring having at least one heteroatom chosen from N, O and/or S as ring atom. It can be substituted or unsubstituted. It can be aromatic or non-aromatic.

### Thixotropic Composition

The thixotropic composition according to the invention comprises a diurea-diurethane compound or a mixture of diurea-diurethane compounds and an aprotic solvent as are described below.

The composition according to the invention is stable although it contains little or no salt. The thixotropic composition according to the invention contains less than 0.1 mol of salt per urea group in the composition, aprotic solvent excluded. The number of urea groups is determined over the whole of the compounds contained in the composition, aprotic solvent excluded. The compound(s) of formula (I) contain(s) 2 urea groups. If the composition contains 1 mol of compound(s) of formula (I) and if there is no other compound having at least one urea group in the composition, then the composition contains less than 0.2 mol of salt.

In particular, the thixotropic composition can contain from 0 to less than 0.1 mol, or from 0 to 0.09 mol, or from 0 to 0.07 mol, or from 0 to 0.05 mol, or from 0 to 0.03 mol, or from 0 to 0.01 mol, or from 0 to 0.001 mol, of salt per urea group in the composition, aprotic solvent excepted.

More particularly, the thixotropic composition can contain less than 1%, or from 0% to 0.9%, or from 0% to 0.7%, or from 0% to 0.5%, or from 0% to 0.25%, or from 0% to 0.2%, or from 0% to 0.15%, or from 0% to 0.09%, or from 0% to 0.03%, by weight of LiCl, with respect to the weight of the composition, aprotic solvent excepted.

More particularly, the thixotropic composition can contain less than 1.6%, or from 0% to 1.4%, or from 0% to 1.1%, or from 0% to 0.8%, or from 0% to 0.4%, or from 0% to 0.3%, or from 0% to 0.25%, or from 0% to 0.15%, or from 0% to 0.05%, by weight of LiNO₃, with respect to the weight of the composition, aprotic solvent excepted.

The salt can in particular be chosen from a metal salt, an ionic liquid and an ammonium salt. In particular, the salt can be a metal salt chosen from a halide, an acetate, a formate or a nitrate. More particularly, the salt can be a lithium salt. More particularly still, the salt can be a lithium salt chosen from LiCl, LiNO₃, LiBr and their mixtures.

The composition according to the invention can in particular be stable without addition of stabilizer, such as, in particular, a surfactant. According to a specific embodiment, the thixotropic composition according to the invention contains less than 0.1 mol of surfactant per urea group in the composition.

In particular, the thixotropic composition can contain from 0 to 0.1 mol, or from 0 to 0.08 mol, or from 0 to 0.06 mol, or from 0 to 0.04 mol, or from 0 to 0.02 mol, or from 0 to 0.01 mol, or from 0 to 0.001 mol, of surfactant per urea group in the composition, aprotic solvent excepted.

More particularly, the thixotropic composition can contain less than 3%, or from 0% to 2.8%, or from 0% to 2.4%, or from 0% to 2%, or from 0% to 1.6%, or from 0% to 1.2%, or from 0% to 1%, or from 0% to 0.5%, or from 0% to 0.1%, or from 0% to 0.01%, by weight of surfactant, with respect to the weight of the composition, aprotic solvent excepted.

The surfactant can in particular be chosen from an anionic surfactant, a cationic surfactant, a non-ionic surfactant, a zwitterionic surfactant and their mixtures. The surfactant can in particular have an HLB of from 8 to 12.

Examples of anionic surfactants are sulfonates, sulfates, sulfosuccinates, phosphates and carboxylates. Examples of cationic surfactants are quaternary ammonium salts (in particular tetraalkylammonium salts and quaternary ammonium esters or esterquats). Examples of non-ionic surfactants are alkoxylated (in particular ethoxylated and/or propoxylated) fatty alcohols, alkylglycosides, esters of fatty acids (in particular glycol esters, glycerol esters, sorbitan esters or sucrose esters of fatty acids) and esters of fatty acids which are alkoxylated (in particular ethoxylated and/or propoxylated). Examples of zwitterionic surfactants are betaines, imidazolines, sultaines, phospholipids and amine oxides.

The composition according to the invention can have an NCO number of less than 0.5 mg KOH/g, in particular of less than 0.2 mg KOH/g, more particularly of less than 0.1 mg KOH/g, more particularly still 0 mg KOH/g. The NCO number can be measured according to the method described below.

### Compound of Formula (I)

The thixotropic composition according to the invention comprises a compound of formula (I) or a mixture of compounds of formula (I):

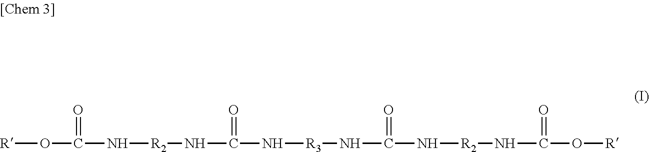

in which the R′, R₂ and R₃ groups are as defined below.

Preferably, the compounds of formula (I) do not contain a tertiary amine functional group or a quaternary ammonium functional group.

The compound(s) of formula (I) can in particular correspond to the reaction product(s) of at least one alcohol of formula R′—OH, of at least one diisocyanate of formula OCN—R₂—NCO and of at least one diamine of formula H₂N—R₃—NH₂.

The thixotropic composition can in particular comprise from 5% to 80%, in particular from 15% to 75%, more particularly from 25% to 65%, in moles, of compound of formula (I), with respect to the total molar amount of compounds having one or more functional groups chosen from urea, urethane and their mixtures, aprotic solvent excepted.

### R′ Group

A compound of formula (I) contains two R′ groups. The R′ groups of one and the same compound of formula (I) can be identical or different. The composition according to the invention can comprise a mixture of compounds of formula (I) having identical R′ groups. The composition according to the invention can comprise a mixture of compounds of formula (I) which differ in their R′ groups. For example, some compounds of the mixture can have identical R′ groups and some compounds of the mixture can have different R′ groups.

Each R′ group can originate from the use of an alcohol of formula R′—OH to form the diurea-diurethane compound(s) of formula (I). The R′ group can correspond to the residue of an alcohol of formula R′—OH without the OH group. The R′ groups and the corresponding alcohols of formula R′—OH described below also apply to the process according to the invention.

Each R′ is independently chosen from alkyl, alkenyl, cycloalkyl, aryl, arylalkyl, •—[(CRₐR_{b})ₙ—O]ₘ—Y and •—[(CR_{c}R_{d})ₚ—C(═O)O]_{q}—Z;
the symbol • represents a point of attachment to a urethane group of the formula (I);
Y and Z are independently chosen from alkyl, alkenyl, cycloalkyl, aryl and arylalkyl;
Rₐ, R_{b}, R_{c} and R_{d} are independently chosen from H and methyl, in particular H;
each n is independently equal to 2, 3 or 4, in particular n is 2;
m ranges from 1 to 30, in particular m ranges from 2 to 25;
p ranges from 3 to 5, in particular p is 5;
q ranges from 1 to 20, in particular q ranges from 2 to 10.

An R′ group can be an alkyl, in particular a C₁ to C₃₀ alkyl. Examples of suitable alkyl groups are methyl, propyl, 1-methylethyl, butyl, X₁₋₂-methylpropyl, pentyl, X₁₋₃-methylbutyl, hexyl, X₁₋₄-methylpentyl, heptyl, X₁₋₅-methylhexyl, octyl, X₁₋₆-methylheptyl, 2-ethylhexyl, nonyl, X₁₋₇-methyloctyl, decyl, X₁₋₈-methylnonyl, undecyl, X₁₋₉-methyldecyl, dodecyl, X₁₋₁₀-methylundecyl, tridecyl, X₁₋₁₁-methyldodecyl, 2,5,9-trimethyldecyl, tetradecyl, X₁₋₁₂-methyltridecyl, pentadecyl, X₁₋₁₃-methyltetradecyl, hexadecyl, X₁₋₁₄-methylpentadecyl, heptadecyl, X₁₋₁₅-methylhexadecyl, octadecyl, X₁₋₁₆-methylheptadecyl, nonadecyl, X₁₋₁₇-methyloctadecyl, icosyl, X₁₋₁₈-methylnonadecyl, henicosyl, X₁₋₁₉-methylicosyl, docosyl, X₁₋₂₀-methylhenicosyl, 2-propylheptyl, 2-propylnonyl, 2-pentylnonyl, 2-butyloctyl, 2-butyldecyl, 2-hexyloctyl, 2-hexyldecyl, 2-octyldecyl, 2-hexyldodecyl, 2-octyldodecyl, 2-decyltetradecyl, 6-methyldodecyl and their isomers, in which X_{a-b} represents an integer which can take all the values ranging from a to b, X_{a-b} indicating the position of the substituent in the alkyl group. The X₁₋ₙ-methyldodecyl group is a dodecyl group substituted by a methyl group in the 1, 2, 3, 4, 5, 6, 7, 8, 9, 10 or 11 position, for example 11-methyldodecyl or 2-methyldodecyl. The term “isomers” is understood to mean the alkyl groups comprising the same number of carbon atoms but having a different substitution scheme, for example an ethyl substituent instead of a methyl substituent or a greater number of methyl substituents. Thus, the 2,5,9-trimethyldecyl group is an isomer of the 11-methyldodecyl or 2-methyldodecyl group. The abovementioned alkyl groups can in particular be bonded to the urethane group in the 1 position. Thus, the 2,5,9-trimethyldecyl group can be represented by the following formula:

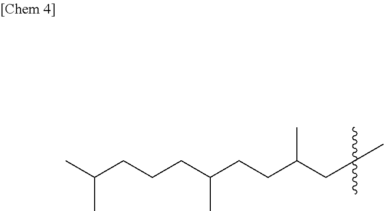 [SMILES: *CC(C)CCC(C)CCCC(C)C]

in which the broken line represents a point of attachment to a urethane group of the compound of formula (I).

An R′ group can be an alkenyl, in particular a C₂ to C₃₀ alkenyl. Examples of suitable alkenyl groups are hex-Y₂₋₅-enyl, hept-Y₂₋₆-enyl, oct-Y₂₋₇-enyl, non-Y₂₋₈-enyl, dec-Y₂₋₉-enyl, undec-Y₂₋₁₀-enyl, dodec-Y₂₋₁₁-enyl, tridec-Y₂₋₁₂-enyl, tetradec-Y₂₋₁₃-enyl, hexadec-Y₂₋₁₅-enyl, octadec-Y₂₋₁₇-enyl, icos-Y₂₋₁₉-enyl, docos-Y₂₋₂₁-enyl, heptadeca-8,11-dienyl, octadeca-9,12-dienyl, nonadeca-10,13-dienyl, icosa-11,14-dienyl, docosa-13,16-dienyl, octadeca-5,9,12-trienyl, octadeca-6,9,12-trienyl, octadeca-9,12,15-trienyl, octadeca-9,11,13-trienyl, icosa-8,11,14-trienyl and icosa-11,14,17-trienyl, in which Y_{a-b} represents an integer which can take all the values ranging from a to b, Y_{a-b} indicating the position of the double bond in the alkenyl group. The hex-Y₂₋₅-enyl group is a hexenyl group in which the double bond can be in the 2, 3, 4 or 5 position, which corresponds to the hex-2-enyl, hex-3-enyl, hex-4-enyl and hex-5-enyl groups. The abovementioned alkenyl groups can in particular be bonded to the urethane group in the 1 position. Thus, the hex-2-enyl group can be represented by the following formula:

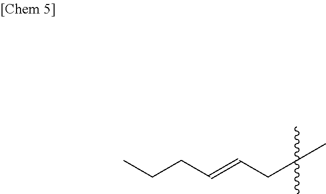 [SMILES: *C/C=C/CCC]

in which the broken line represents a point of attachment to a urethane group of the compound of formula (I).

An R′ group can be a cycloalkyl, in particular a C₅ to C₁₂ cycloalkyl. Examples of suitable cycloalkyl groups are cyclopentyl, cyclohexyl, cycloheptyl, cycloctyl, cyclononyl, cyclodecyl, cycloundecyl and cyclododecyl.

An R′ group can be an aryl, in particular a C₆ to C₁₂ aryl. Examples of suitable aryl groups are phenyl, naphthyl, biphenyl, ortho-, meta or para-tolyl, 2,3-, 2.4-, 2,5-, 2,6-, 3,4- or 3,5-xylyl and mesityl.

An R′ group can be an arylalkyl, in particular a C₇ to C₁₂ arylalkyl. Examples of suitable arylalkyl groups are benzyl, 2-phenylethyl, 3-phenylpropyl, 4-phenylbutyl and 2-phenylbutyl.

An R′ group can be a •—[(CRₐR_{b})ₙ—O]ₘ—Y group in which:
Y is chosen from alkyl, alkenyl, cycloalkyl, aryl and arylalkyl;
Rₐ and R_{b} are independently chosen from H and methyl, in particular H;
each n is independently equal to 2, 3 or 4, in particular n is 2;
m ranges from 1 to 30, in particular m ranges from 2 to 25.

Examples of •—[(CRₐR_{b})ₙ—O]ₘ—Y groups are the alkoxylated derivatives of the alkyl, alkenyl, cycloalkyl, aryl and alkylaryl groups described above. Polyethylene glycols, polypropylene glycols, co-poly(ethylene glycol/propylene glycol) and polytetramethylene glycols comprising an end group chosen from an alkyl, alkenyl, cycloalkyl, aryl and arylalkyl group as described above are suitable in particular. These groups can in particular be obtained by reacting an alcohol R′OH having an R′ group as described above with a cyclic compound chosen from ethylene oxide, propylene oxide, tetrahydrofuran and their mixtures.

An R′ group can be a •—[(CR_{c}R_{d})ₚ—C(═O)O]_{q}—Z group in which:
Z is chosen from alkyl, alkenyl, cycloalkyl, aryl and arylalkyl;
R_{c} and R_{d} are independently chosen from H and methyl, in particular H;
p ranges from 3 to 5, in particular p is 5;
q ranges from 1 to 20, in particular q ranges from 2 to 10.

Examples of •—[(CR_{c}R_{d})ₚ—C(═O)O]_{q}—Z groups are the esterified derivatives of the alkyl, alkenyl, cycloalkyl, aryl and arylalkyl groups described above. Polyesters comprising an end group chosen from an alkyl, alkenyl, cycloalkyl, aryl and arylalkyl group as described above are suitable in particular. These groups can in particular be obtained by reacting an alcohol R′OH having an R′ group as described above with a lactone chosen from γ-butyrolactone, δ-valerolactone, ε-caprolactone and their mixtures.

According to one embodiment, each R′ is independently chosen from alkyl and •—[(CRₐR_{b})ₙ—O]ₘ—Y as defined above. In particular, each R′ is independently chosen from linear or branched C₁-C₃₀ alkyl and •—[CH₂—CH₂—O]ₘ—Y with Y a C₁-C₂₄ alkyl and m ranging from 1 to 25. More particularly, each R′ is independently chosen from branched C₈-C₂₀ alkyl and •—[CH₂—CH₂—O]ₘ—Y with Y a C₁-C₆ alkyl and m ranging from 1 to 20.

More particularly still, each R′ is independently chosen from octyl, X₁₋₆-methylheptyl, 2-ethylhexyl, nonyl, X₁₋₇-methyloctyl, decyl, X₁₋₈-methylnonyl, undecyl, X₁₋₉-methyldecyl, dodecyl, X₁₋₁₀-methylundecyl, tridecyl, X₁₋₁₁-methyldodecyl, 2,5,9-trimethyldecyl, tetradecyl, X₁₋₁₂-methyltridecyl, pentadecyl, X₁₋₁₃-methyltetradecyl, hexadecyl, X₁₋₁₄-methylpentadecyl, heptadecyl, X₁₋₁₅-methylhexadecyl, octadecyl, X₁₋₁₆-methylheptadecyl, nonadecyl, X₁₋₁₇-methyloctadecyl, icosyl, X₁₋₁₈-methylnonadecyl, henicosyl, X₁₋₁₉-methylicosyl, docosyl, X₁₋₂₀-methylhenicosyl, 2-propylheptyl, 2-propylnonyl, 2-pentylnonyl, 2-butyloctyl, 2-butyldecyl, 2-hexyloctyl, 2-hexyldecyl, 2-octyldecyl, 2-hexyldodecyl, 2-octyldodecyl, 2-decyltetradecyl, 6-methyldodecyl and their isomers, •—[CH₂—CH₂—O]₃—(CH₂)₃—CH₃ and •—[CH₂—CH₂—O]ₘ—CH₃ with m=2 to 20.

A compound of formula (I) can have identical or different R′ groups. A compound of formula (I) can have R′ groups having a different molecular weight. A compound of formula (I) can have R′ groups having a chemical nature, in particular a hydrophilicity, which is different.

The composition according to the invention can comprise a compound of formula (I) in which the R′ groups are identical. The composition according to the invention can comprise a compound of formula (I) in which the R′ groups are different. The composition according to the invention can comprise a compound of formula (I) in which the R′ groups are identical and a compound of formula (I) in which the R′ groups are different.

The composition according to the invention can in particular comprise a compound of formula (I) in which the R′ groups are identical. The R′ groups can be identical and correspond to R₁, R₁ being a linear or branched C₁-C₃₀ alkyl, in particular a linear or branched C₈-C₂₀ alkyl, more particularly a branched C₈-C₂₀ alkyl, as described above.

The composition according to the invention can in particular comprise a mixture of compounds of formula (I), said mixture containing at least one compound of formula (I) in which the R′ groups are different. The mixture can contain at least one compound of formula (I) in which the R′ groups have a different molecular weight. The mixture can contain at least one compound of formula (I) in which the R′ groups have a chemical nature, in particular a hydrophilicity, which is different.

A composition comprising a compound of formula (I) in which the R′ groups are different can in particular be obtained by using a mixture of at least 2 different alcohols R′—OH, corresponding in particular to R₄—OH and R₅—OH, to form the compound(s) of formula (I).

In particular, the mixture of compounds of formula (I) can contain:
at least one compound of formula (I) in which the R′ groups are different, one of the R′ groups corresponding to R₄ and the other R′ group corresponding to R₅;
optionally a compound of formula (I) in which the R′ groups are identical and correspond to R₄;
optionally a compound of formula (I) in which the R′ groups are identical and correspond to R₅;
R₄ and R₅ being as defined above for R′.

The mixture of compounds of formula (I) can in particular comprise a compound of formula (Ia), optionally as a mixture with a compound of formula (Ib) and/or a compound of formula (Ic):

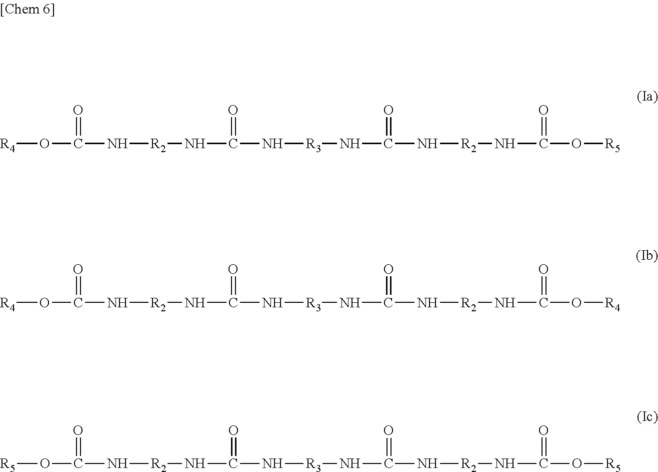

in which:
all the R₄ groups are identical and as defined above for R′;
all the R₅ groups are identical and as defined above for R′;
the R₄ groups are different from R₅.

The R₄ group can be more hydrophobic than the R₅ group; and/or the R₅ group can have a higher molecular weight than that of the R₄ group.

The molecular weights of the R₄ and R₅ groups can be different. In particular, the R₄ group can have a lower molecular weight than that of the R₅ group. More particularly, the difference between the molecular weight of the R₄ group and that of the R₅ group can be at least 50, at least 100, at least 150, at least 200, at least 300 or at least 350 g/mol.

The chemical natures of the R₄ and R₅ groups can be different. In particular, the R₄ group can be more hydrophobic than the R₅ group.

The R₄ and R₅ groups can be groups of formula •—[(CRₐR_{b})ₙ—O]ₘ—Y having different molecular weights, Y, Rₐ, R_{b}, n and m being as defined above. Alternatively, the R₄ group can be a linear or branched C₁-C₃₀ alkyl and the R₅ group can be a group of formula •—[(CRₐR_{b})ₙ—O]ₘ—Y in which Y, Rₐ, R_{b}, n and m are as defined above.

The total molar amount of R₅ group, in particular of the least hydrophobic group and/or of the group having the highest molecular weight, can in particular represent more than 20%, in particular from 25% to 95%, 30% to 90%, 35% to 85%, or 40% to 80%, of the total molar amount of the R₄ and R₅ groups of all of the products having one or more functional groups chosen from urea, urethane and their mixtures in the composition according to the invention, aprotic solvent excepted.

The composition according to the invention can in particular comprise a mixture of compounds of formula (I), said mixture containing at least two different compounds of formula (I) in which the R′ groups are different. The mixture can contain at least two different compounds of formula (I) in which the R′ groups have a different molecular weight. The mixture can contain at least two different compounds of formula (I) in which the R′ groups have a chemical nature, in particular a hydrophilicity, which is different.

A composition comprising at least two compounds of formula (I) in which the R′ groups are different can in particular be obtained by using a mixture of at least 3 different alcohols R′—OH, corresponding in particular to R₄—OH, R₅—OH and R₆—OH, to form the diurea-diurethane compound(s) of formula (I).

The mixture of compounds of formula (I) can contain:
at least one compound of formula (I) in which the R′ groups are different, one of the R′ groups corresponding to R₄ and the other R′ group corresponding to R₅; and
at least one compound of formula (I) in which the R′ groups are different, one of the R′ groups corresponding to R₄ and the other R′ group corresponding to R₆;
optionally a compound of formula (I) in which the R′ groups are different, one of the R′ groups corresponding to R₅ and the other R′ group corresponding to R₆;
optionally a compound of formula (I) in which the R′ groups are identical and correspond to R₄;
optionally a compound of formula (I) in which the R′ groups are identical and correspond to R₅;
optionally a compound of formula (I) in which the R′ groups are identical and correspond to R⁶;
R₄, R₅ and R₆ being as defined above for R′.

The mixture of compounds of formula (I) can in particular comprise a compound of formula (Ia), a compound of formula (Id) and optionally one or more compounds of formula (Ib), (Ic), (Ie) or (If) which are represented below:

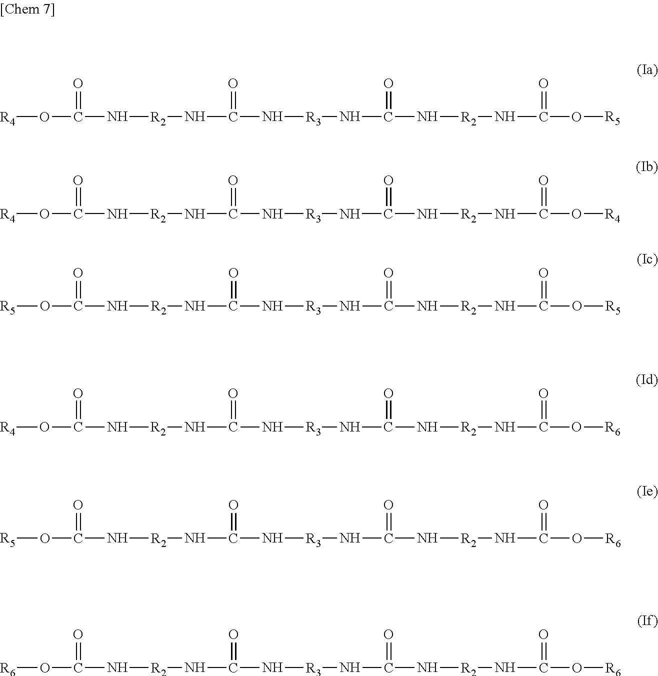

in which:
all the R₄ groups are identical and as defined above for R′;
all the R₅ groups are identical and as defined above for R′;
all the R₆ groups are identical and as defined above for R′;
the R₄ groups are different from R₅;
the R₄ groups are different from R₆;
the R₅ groups are different from R₆.

The R₄ group can be more hydrophobic than the R₅ group and/or than the R₆ group; and/or the R₄ group can have a lower molecular weight than that of the R₅ group and/or than that of the R₆ group.

The molecular weights of the R₄, R₅ and R₆ groups can be different. In particular, the R₄ group can have a lower molecular weight than that of the R₅ group; and/or the R₄ group can have a lower molecular weight than that of the R₆ group; and/or the R₅ group can have a lower molecular weight than that of the R₆ group. More particularly, the R₄ group has a lower molecular weight than those of the R₅ and R₆ groups. More particularly still, the difference between the molecular weight of the R₄ group and that of the R₅ group; and/or the difference between the molecular weight of the R₄ group and that of the R₆ group; and/or the difference between the molecular weight of the R₅ group and that of the R₆ group can be at least 50, at least 100, at least 150, at least 200, at least 300 or at least 350 g/mol.

The R₄, R₅ and R₆ groups can have different chemical natures. In particular, the R₄ group can be more hydrophobic than the R₅ group; and/or the R₄ group can be more hydrophobic than the R₆ group; and/or the R₅ group can be more hydrophobic than the R₆ group. More particularly, the R₄ group is more hydrophobic than the R₅ and R₆ groups.

The R₄ group can be a linear or branched C₁-C₃₀ alkyl and the R₅ and R₆ groups can be groups of formula •—[(CRₐR_{b})ₙ—O]ₘ—Y having different molecular weights, Y, Rₐ, R_{b}, n and m being as defined above.

The total molar amount of the R₅ and R₆ groups, in particular the total molar amount of the least hydrophobic groups and/or of the groups having the highest molecular weights, can in particular represent more than 20%, in particular from 25% to 95%, 30% to 90%, 35% to 85%, or 40% to 80%, of the total molar amount of the R₄, R₅ and R₆ groups of all of the products having one or more functional groups chosen from urea, urethane and their mixtures in the composition according to the invention, aprotic solvent excepted.

According to a preferred embodiment, more than 20 mol %, in particular from 25 mol % to 95 mol %, 30 mol % to 90 mol %, 35 mol % to 85 mol %, or 40 mol % to 80 mol %, of all of the R′ groups contained in the compound(s) of formula (I) are hydrophilic groups, in particular •—[(CRₐR_{b})ₙ—O]ₘ—Y groups.

The R′ groups can in particular be the residues of one or more alcohols of formula R′—OH without the OH group. An alcohol R′—OH can in particular be chosen from a C₁ to C₃₀ alkane substituted by an OH group, a C₂ to C₃₀ alkene substituted by an OH group, a C₅ to C₁₂ cycloalkane substituted by an OH group, a C₆ to C₁₂ arene substituted by an OH group, a C₇ to C₁₂ arylalkane substituted by an OH group, HO—[(CRₐR_{b})ₙ—O]ₘ—Y and HO—[(CR_{c}R_{d})ₚ—C(═O)O]_{q}—Z
Y and Z are independently chosen from C₁ to C₃₀ alkyl, C₂ to C₃₀ alkenyl, C₅ to C₁₂ cycloalkyl, C₆ to C₁₂ aryl and C₇ to C₁₂ arylalkyl;
Rₐ, R_{b}, R_{c} and R_{d} are independently chosen from H and methyl, in particular H;
each n is independently equal to 2, 3 or 4, in particular n is 2;
m ranges from 1 to 30, in particular m ranges from 2 to 25;
p ranges from 3 to 5, in particular p is 5;
q ranges from 1 to 20, in particular q ranges from 2 to 10.

A C₁ to C₃₀ alkane substituted by an OH group can in particular be chosen from octan-1-ol, octan-2-ol, X₁₋₆-methylheptan-1-ol, 2-ethylhexan-1-ol, nonan-1-ol, X₁₋₇-methyloctan-1-ol, decan-1-ol, X₁₋₈-methylnonan-1-ol, undecan-1-ol, X₁₋₉-methyldecan-1-ol, dodecan-1-ol, X₁₋₁₀-methylundecan-1-ol, tridecan-1-ol, X₁₋₁₁-methyldodecan-1-ol, 2,5,9-trimethyldecan-1-ol, tetradecan-1-ol, X₁₋₁₂-methyltridecan-1-ol, pentadecan-1-ol, X₁₋₁₃-methyltetradecan-1-ol, hexadecan-1-ol, X₁₋₁₄-methylpentadecan-1-ol, heptadecan-1-ol, X₁₋₁₅-methylhexadecan-1-ol, octadecan-1-ol, X₁₋₁₆-methylheptadecan-1-ol, nonadecan-1-ol, X₁₋₁₇-methyloctadecan-1-ol, icosan-1-ol, X₁₋₁₈-methylnonadecan-1-ol, henicosan-1-ol, X₁₋₁₉-methylicosan-1-ol, docosan-1-ol, X₁₋₂₀-methylhenicosan-1-ol, 2-propylheptan-1-ol, 2-propylnonan-1-ol, 2-pentylnonan-1-ol, 2-butyloctan-1-ol, 2-butyldecan-1-ol, 2-hexyloctan-1-ol, 2-hexyldecan-1-ol, 2-octyldecan-1-ol, 2-hexyldodecan-1-ol, 2-octyldodecan-1-ol, 2-decyltetradecan-1-ol, 6-methyldodecan-1-ol and their isomers, in which X_{a-b} represents an integer which can take all the values ranging from a to b, X_{a-b} indicating the position of an alkyl substituent on the alkane. X₁₋₁₁-methyldodecan-1-ol is a dodecane substituted by an OH group in the 1 position and a methyl group in the 1, 2, 3, 4, 5, 6, 7, 8, 9, 10 or 11 position, for example 2-methyldodecan-1-ol or 11-methyldodecan-1-ol. The term “isomers” is understood to mean the alkanes comprising the same number of carbon atoms but having a different substitution scheme, for example an ethyl substituent instead of a methyl substituent or a greater number of methyl substituents. Thus, 2,5,9-trimethyldecan-1-ol is an isomer of 2-methyldodecan-1-ol and of 11-methyldodecan-1-ol. Preferably, the C₁ to C₃₀ alkane substituted by an OH group is chosen from 11-methyldodecan-1-ol and 2,5,9-trimethyldecan-1-ol.

A C₂ to C₃n alkene substituted by an OH group can in particular be chosen from Y₂₋₅-hexen-1-ol, Y₂₋₆-hepten-1-ol, Y₂₋₇-octen-1-ol, Y₂₋₈-nonen-1-ol, Y₂₋₉-decen-1-ol, Y₂₋₁₀-undecen-1-ol, Y₂₋₁₁-dodecen-1-ol, Y₂₋₁₂-tridecen-1-ol, Y₂₋₁₃-tetradecen-1-ol, Y₂₋₁₅-hexadecen-1-ol, Y₂₋₁₇-octadecen-1-ol, Y₂₋₁₉-icosen-1-ol, Y₂₋₂₁-docosen-1-ol, heptadeca-8,11-dien-1-ol, octadeca-9,12-dien-1-ol, nonadeca-10,13-dien-1-ol, icosa-11,14-dien-1-ol, docosa-13,16-dien-1-ol, octadeca-5,9,12-trien-1-ol, octadeca-6,9,12-trien-1-ol, octadeca-9,12,15-trien-1-ol, octadeca-9,11,13-trien-1-ol, icosa-8,11,14-trien-1-ol, icosa-11,14,17-trien-1-ol, in which Y_{a-b} represents an integer which can take all the values ranging from a to b, Y_{a-b} indicating the position of the double bond in the alkene. Y₂₋₅-hexen-1-ol is a hexene substituted by an OH in the 1 position in which the double bond can be in the 2, 3, 4 or 5 position.

A C₅ to C₁₂ cycloalkane substituted by an OH group can in particular be chosen from cyclopentanol, cyclohexanol, cycloheptanol, cycloctanol, cyclononanol, cyclodecanol, cycloundecanol and cyclododecanol, preferably cyclopentanol and cyclohexanol.

A C₆ to C₁₂ arene substituted by an OH group can in particular be chosen from phenol, 1- or 2-naphthol, 2-, 3- or 4-phenylphenol, 2-, 3- or 4-methylphenol, 2,3-, 2,4-, 2,5-, 2,6-, 3,4- or 3,5-dimethylphenol and 2,4,6-, 2,3,5- or 2,3,6-trimethylphenol.

A C₇ to C₁₂ arylalkane substituted by an OH group can in particular be chosen from benzyl alcohol, 2-phenylethan-1-ol, 3-phenylpropan-1-ol, 4-phenylbutan-1-ol and 2-phenylbutan-1-ol, preferably benzyl alcohol and 2-phenylethan-1-ol.

An alcohol HO—[(CRₐR_{b})ₙ—O]ₘ—Y can in particular be chosen from an alkoxylated derivative of a C₁ to C₃₀ alkane substituted by an OH group as defined above, an alkoxylated derivative of a C₂ to C₃₀ alkene substituted by an OH group as defined above, an alkoxylated derivative of a C₅ to C₁₂ cycloalkane substituted by an OH group as defined above, an alkoxylated derivative of a C₆ to C₁₂ arene substituted by an OH group as defined above, an alkoxylated derivative of a C₇ to C₁₂ arylalkane substituted by an OH group as defined above. An alkoxylated derivative can in particular be an ethoxylated, propoxylated and/or butoxylated derivative, preferably an ethoxylated derivative.

Preferably, the alcohol HO—[(CRₐR_{b})ₙ—O]ₘ—Y is chosen from a polyethylene glycol monomethyl ether (MPEG), a polyethylene glycol monoethyl ether and a polyethylene glycol monobutyl ether; more preferentially an MPEG having a number-average molecular weight of from 200 to 1000 g/mol (in particular MPEG-250, MPEG-350, MPEG-400, MPEG-450, MPEG-500, MPEG-550, MPEG-650 or MPEG-750), or triethylene glycol monobutyl ether (also known as butyl triglycol (BTG)).

An alcohol HO—[(CR_{c}R_{d})ₚ—C(═O)O]_{q}—Z can in particular be a polyester derivative of a C₁ to C₃₀ alkane substituted by an OH group as defined above, a polyester derivative of a C₂ to C₃₀ alkene substituted by an OH group as defined above, a polyester derivative of a C₅ to C₁₂ cycloalkane substituted by an OH group as defined above, a polyester derivative of a C₆ to C₁₂ arene substituted by an OH group as defined above, a polyester derivative of a C₇ to C₁₂ arylalkane substituted by an OH group as defined above. A polyester derivative can in particular comprise a polyester part obtained by ring opening polymerization of a lactone, preferably chosen from γ-butyrolactone, δ-valerolactone, ε-caprolactone and their mixtures.

### R₂ Group

A compound of formula (I) contains two R₂ groups. The R₂ groups of one and the same compound of formula (I) can be identical or different. The composition according to the invention can comprise a mixture of compounds of formula (I) having identical R₂ groups. The composition according to the invention can comprise a mixture of compounds of formula (I) which differ in their R₂ groups. For example, some compounds of the mixture can have identical R₂ groups and some compounds of the mixture can have different R₂ groups.

Each R₂ group can originate from the use of a diisocyanate of formula OCN—R₂—NCO in order to form the diurea-diurethane compound(s) of formula (I). The R₂ group can correspond to the residue of a diisocyanate of formula OCN—R₂—NCO without the NCO groups. The R₂ groups and the corresponding diisocyanates of formula OCN—R₂—NCO described below also apply to the process according to the invention.

Each R₂ is independently a divalent group chosen from an aliphatic group, a cycloaliphatic group, an aromatic group and an araliphatic group.

According to one embodiment, each R₂ is independently an aromatic group.

In particular, each R₂ is independently an aromatic group having the following formula:

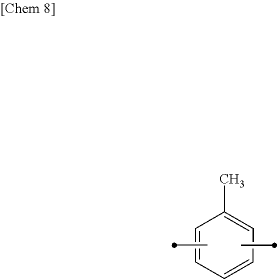

in which the symbol • represents a point of attachment to a urea or urethane group of the formula (I).

More particularly, each R₂ is independently an aromatic group having one of the following formulae:

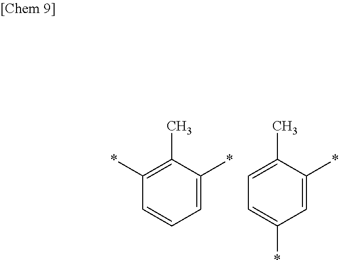

in which the symbol • represents a point of attachment to a urea or urethane group of the formula (I).

The thixotropic composition according to the invention can in particular have more than 85 mol %, more than 90 mol %, more than 95 mol %, more than 97 mol %, more than 98 mol %, more than 99 mol %, or 100 mol %, of all of the R₂ groups contained in the compound(s) of formula (I) which are aromatic groups of the following formula:

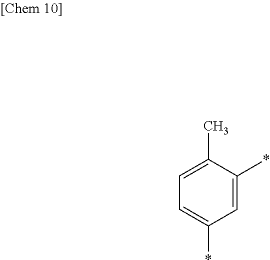 [SMILES: *c1ccc(C)c(*)c1]

in which the symbol • represents a point of attachment to a urea or urethane group of the formula (I).

In particular, the thixotropic composition according to the invention can have from 86 mol % to 100 mol %, from 90 mol % to 100 mol %, from 95 mol % to 100 mol %, from 97 mol % to 100 mol %, from 98 mol % to 100 mol %, from 99 mol % to 100 mol %, or 100 mol %, of all of the R₂ groups contained in the compound(s) of formula (I) which are aromatic groups of the following formula:

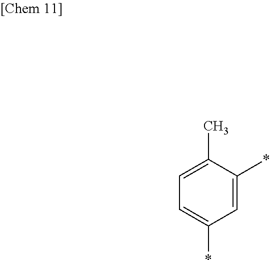 [SMILES: *c1ccc(C)c(*)c1]

in which the symbol • represents a point of attachment to a urea or urethane group of the formula (I).

The R₂ group is bonded, on one side, to a urethane group (originating from the reaction between an isocyanate group of the diisocyanate OCN—R₂—NCO and the OH group of the alcohol R′OH) and, on the other side, to a urea group (originating from the reaction between the other isocyanate group of the diisocyanate OCN—R₂—NCO and an NH₂ group of the diamine H₂N—R₃—NH₂).

More particularly still, each R₂ is independently an aromatic group of the following formula:

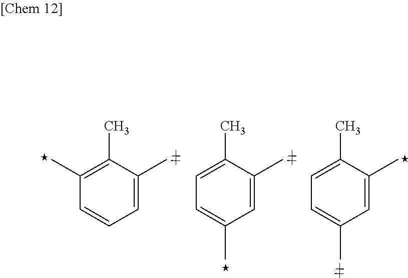

in which the symbol [symbol] represents a point of attachment to a urethane group of the formula (I) and the symbol [symbol] represents a point of attachment to a urea group of the formula (I).

When the R₂ group is asymmetric, there may be a side of the R₂ group which is preferably bonded to the urethane group and the other side which is preferably bonded to the urea group. Without wishing to be committed to any one theory, the Applicant Company assumes that the least hindered side of the R₂ group is preferably bonded to the urethane group.

The thixotropic composition according to the invention can in particular have more than 60 mol %, more than 65 mol %, more than 70 mol %, more than 75 mol %, more than 80 mol %, more than 85 mol %, or more than 90 mol %, of all of the R₂ groups contained in the compound(s) of formula (I) which are aromatic groups of the following formula:

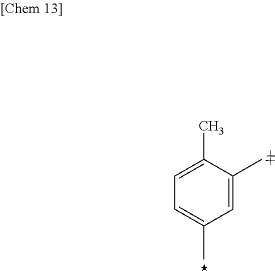

in which the symbol [symbol] represents a point of attachment to a urethane group of the formula (I) and the symbol [symbol] represents a point of attachment to a urea group of the formula (I).

In particular, the thixotropic composition according to the invention can have from 61 mol % to 100 mol %, from 65 mol % to 100 mol %, from 70 mol % to 100 mol %, from 75 mol % to 100 mol %, from 80 mol % to 100 mol %, from 85 mol % to 100 mol %, or from 90 mol % to 100 mol %, of all of the R₂ groups contained in the compound(s) of formula (I) which are aromatic groups of the following formula:

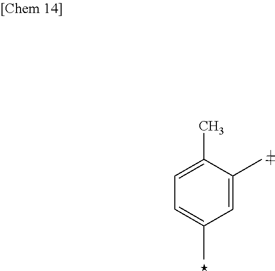

in which the symbol [symbol] represents a point of attachment to a urethane group of the formula (I) and the symbol [symbol] represents a point of attachment to a urea group of the formula (I).

The R₂ groups can in particular be the residues of one or more diisocyanates of formula OCN—R₂—NCO without the NCO groups. A diisocyanate of formula OCN—R₂—NCO can be a toluene diisocyanate (TDI). A TDI can be in the form of one or more isomers chosen from toluene-2,4-diisocyanate and toluene-2,6-diisocyanate.

In the context of the present invention, it is advantageous to use a TDI which comprises a high proportion of toluene-2,4-diisocyanate, indeed even a TDI which comprises only toluene-2,4-diisocyanate. The Applicant Company assumes that the asymmetry of this compound makes it possible to decrease the amount of by-products, in particular of compound of formula (II), in the composition. This makes it possible to obtain compounds of formula (I) having a high proportion, indeed even consisting exclusively, of R₂ groups according to the following formula:

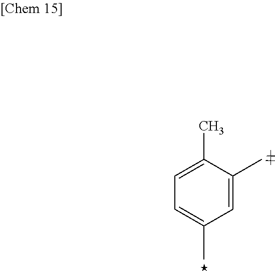

in which the symbol [symbol] represents a point of attachment to a urethane group of the formula (I) and the symbol [symbol] represents a point of attachment to a urea group of the formula (I).

In particular, a diisocyanate of formula OCN—R₂—NCO is a TDI containing more than 85 mol %, more than 90 mol %, more than 95 mol %, more than 97 mol %, more than 98 mol %, more than 99 mol %, or 100 mol %, of toluene-2,4-diisocyanate, with respect to the total amount of toluene diisocyanate isomers. More particularly, a diisocyanate of formula OCN—R₂—NCO is a TDI containing from 86 mol % to 100 mol %, from 90 mol % to 100 mol %, from 95 mol % to 100 mol %, from 97 mol % to 100 mol %, from 98 mol % to 100 mol %, from 99 mol % to 100 mol %, or 100 mol %, of toluene-2,4-diisocyanate, with respect to the total amount of toluene diisocyanate isomers. Preferably, a diisocyanate of formula OCN—R₂—NCO is a TDI containing 100 mol % of toluene-2,4-diisocyanate, with respect to the total amount of toluene diisocyanate isomers.

### R₃ Group

A compound of formula (I) contains an R₃ group. The composition according to the invention can comprise a mixture of compounds of formula (I) having identical R₃ groups. The composition according to the invention can comprise a mixture of compounds of formula (I) which differ in their R₃ groups.

Each R₃ group can originate from the use of a diamine of formula H₂N—R₃—NH₂ in order to form the diurea-diurethane compound(s) of formula (I). The R₃ group can correspond to the residue of a diamine of formula H₂N—R₃—NH₂ without the NH₂ groups. The R₃ groups and the corresponding diamines of formula H₂N—R₃—NH₂ described below also apply to the process according to the invention.

Each R₃ is independently a divalent group chosen from an aliphatic group, a cycloaliphatic group, an aromatic group, an araliphatic group and a heterocyclic group.

According to a specific embodiment, each R₃ is independently a group chosen from C₂-C₂₄ alkylene, —(CRₕRᵢ)ₛ-[A-(CRⱼRₖ)ₜ]ᵤ—, —(CRₗRₘ)ᵥ—CY—(CRₙRₒ)_{w}— and —(CRₚR_{q})ₓ—CY—(CH₂)_{y}—CY—(CRᵣRₛ)_{z}—;
in which:
A is O or NX;
Rₕ, Rᵢ, Rⱼ, Rₖ, Rₗ, Rₘ, Rₙ, Rₒ, Rₚ, R_{q}, Rᵣ and Rₛ are independently chosen from H and methyl, in particular H;
X is a C₁ to C₆ alkyl, in particular methyl or ethyl;
CY is a ring chosen from phenyl, cyclohexyl, naphthyl, decahydronaphthyl, piperazinyl, triazinyl and pyridinyl, the ring being unsubstituted or substituted by 1 to 3 C₁-C₄ alkyl groups;
s ranges from 2 to 4, in particular s is 2;
t ranges from 2 to 4, in particular t is 2;
u ranges from 1 to 30;
v, w, x, y and z independently range from 0 to 4.

Each R₃ can in particular be a group chosen from C₂-C₂₄ alkylene and —(CRₗRₘ)ᵥ—CY—(CRₙRₒ)_{w}—;
in particular a group chosen from C₂-C₁₈ alkylene and —(CH₂)ᵥ—CY—(CH₂)_{w}— with CY a cyclohexyl or phenyl ring, the ring being unsubstituted or substituted by 1 to 3 C₁-C₄ alkyl groups, v and w ranging from 0 to 1.

More particularly, each R₃ can be a group chosen from C₂-C₆ alkylene and a group having the following formula:

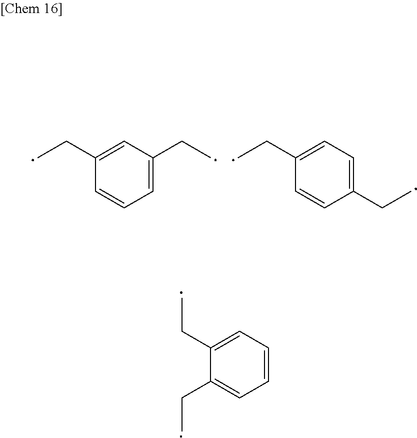

in which the symbol • represents a point of attachment to a urea group of the compound of formula (I).

The thixotropic composition according to the invention can in particular have more than 85 mol %, more than 90 mol %, more than 95 mol %, more than 97 mol %, more than 98 mol %, more than 99 mol %, or 100 mol %, of all of the R₃ groups contained in the compound(s) of formula (I) which are groups of the following formula:

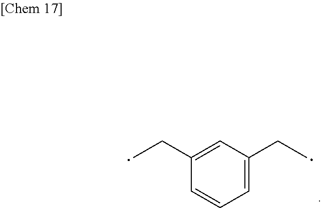

In particular, the thixotropic composition according to the invention can have from 86 mol % to 100 mol %, from 90 mol % to 100 mol %, from 95 mol % to 100 mol %, from 97 mol % to 100 mol %, from 98 mol % to 100 mol %, from 99 mol % to 100 mol %, or 100 mol %, of all of the R₃ groups contained in the compound(s) of formula (I) which are groups of the following formula:

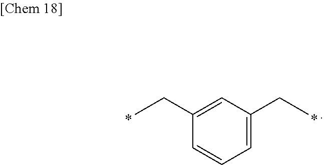

The R₃ group(s) can in particular be the residue(s) of a (of one or more) diamine(s) of formula H₂N—R₃—NH₂ without the NH₂ groups. A diamine of formula H₂N—R₃—NH₂ can be chosen from a C₂ to C₂₄ aliphatic diamine, a C₆ to C₁₈ cycloaliphatic diamine, a C₆ to C₂₄ aromatic diamine, a C₇ to C₂₆ araliphatic diamine and a C₃ to C₁₈ heterocyclic diamine.

A C₂ to C₂₄ aliphatic diamine is a diamine of formula H₂N—R₃—NH₂ in which R₃ is an aliphatic group comprising from 2 to 24 carbon atoms. An aliphatic diamine can be linear or branched, preferably linear. An aliphatic diamine can be a polyetheramine, that is to say a diamine of formula H₂N—R₃—NH₂ in which R₃ comprises ether (—O—) bonds, more particularly ethylene oxide (—O—CH₂—CH₂) and/or propylene oxide (—O—CH₂—CHCH₃—) units. An aliphatic diamine can be a polyalkyleneimine, that is to say a diamine of formula H₂N—R₃—NH₂ in which R₃ is interrupted by one or more tertiary amines (—NX— with X a C₁ to C₆ alkyl). An aliphatic diamine can be interrupted by one or more tertiary amine groups. Examples of linear aliphatic diamines which are suitable are 1,2-ethylenediamine, 1,3-propylenediamine, 1,4-tetramethylenediamine, 1,5-pentamethylenediamine, 1,6-hexamethylenediamine, 1,8-octamethylenediamine, 1,12-dodecamethylenediamine and their mixtures; preferably 1,2-ethylenediamine, 1,5-pentamethylenediamine and 1,6-hexamethylenediamine. Examples of branched aliphatic diamines which are suitable are 1,2-propylenediamine, 2,2-dimethyl-1,3-propanediamine, 2-butyl-2-ethyl-1,5-pentanediamine and their mixtures. Examples of polyetheramines are the compounds sold by Huntsman under the Jeffamine® reference, in particular the Jeffamine® D, ED and EDR series (diamines). These series include in particular the following references: Jeffamine® D-230, Jeffamine® D-400, Jeffamine® D-2000, Jeffamine® D-4000, Jeffamine® ED-600, Jeffamine® ED-900, Jeffamine® ED-2003, Jeffamine® EDR-148 and Jeffamine® EDR-176. An example of polyalkyleneimine is 3,3′-diamino-N-methyldipropylamine.

A C₆ to C₁₈ cycloaliphatic diamine is a diamine of formula H₂N—R₃—NH₂ in which R₃ is a cycloaliphatic group comprising from 6 to 18 carbon atoms. Examples of cycloaliphatic diamines which are suitable are 1,2-, 1,3- or 1,4-diaminocyclohexane, 2-methylcyclohexane-1,3-diamine, 4-methylcyclohexane-1,3-diamine, isophoronediamine, 1,2-, 1,3- or 1,4-bis(aminomethyl)cyclohexane, diaminodecahydronaphthalene, 3,3′-dimethyl-4,4′-diaminodicyclohexylmethane, 4,4′-diaminodicyclohexylmethane, bis(aminomethyl)norbornane and their mixtures;
preferably, 1,3- or 1,4-bis(aminomethyl)cyclohexane, 1,2-, 1,3- or 1,4-bis(aminomethyl)cyclohexane, isophoronediamine and 4,4′-diaminodicyclohexylmethane.

A C₆ to C₂₄ aromatic diamine is a diamine of formula H₂N—R₃—NH₂ in which R₃ is an aromatic group comprising from 6 to 24 carbon atoms. Examples of aromatic diamines which are suitable are ortho-, meta- and para-phenylenediamine, ortho-, meta- and para-tolylenediamine, 3,4′-diaminodiphenyl ether, 4,4′-diaminodiphenyl ether and their mixtures; preferably, ortho-, meta- and para-phenylenediamine.

A C₇ to C₂₆ araliphatic diamine is a diamine of formula H₂N—R₃—NH₂ in which R₃ is an araliphatic group comprising from 7 to 26 carbon atoms. Examples of araliphatic diamines which are suitable are ortho-, meta- and para-xylylenediamine, 4,4′-diaminodiphenylmethane and their mixtures; preferably, ortho-, meta- and para-xylylenediamine.

A C₃ to C₁₈ heterocyclic diamine is a diamine of formula H₂N—R₃—NH₂ in which R₃ is a heterocyclic group comprising from 3 to 18 carbon atoms. Examples of heterocyclic diamines which are suitable are 1,2-diaminopiperazine, 1,4-diaminopiperazine, 1,4-bis(3-aminopropyl)piperazine, 2,3-, 2,6- and 3,4-diaminopyridine, 2,4-diamino-1,3,5-triazine and their mixtures.

### Aprotic Solvent

The thixotropic composition according to the invention comprises an aprotic solvent. The thixotropic composition can comprise a mixture of aprotic solvents.

According to one embodiment, the aprotic solvent is chosen from dimethyl sulfoxide, N,N-dimethylformamide, N,N-dimethylacetamide, N-methylpyrrolidone, N-ethylpyrrolidone, N-propylpyrrolidone, N-butylpyrrolidone, N,N,N′,N′-tetramethylurea and their mixtures. In particular, the aprotic solvent is chosen from dimethyl sulfoxide, N-butylpyrrolidone and their mixtures.

The thixotropic composition can in particular comprise from 20% to 95% by weight, in particular from 40% to 80% by weight and more particularly from 50% to 70% by weight of aprotic solvent, with respect to the weight of the thixotropic composition.

### Diurethane Compound

The thixotropic composition according to the invention can additionally comprise a diurethane compound. The thixotropic composition can comprise a mixture of diurethane compounds.

The diurethane compound can be a by-product resulting from the process for the preparation of the thixotropic composition according to the invention as described below. This is because the reaction between a diisocyanate of formula OCN—R₂—NCO and an alcohol of formula R′—OH in order to form a monoisocyanate adduct of formula R′—O—C(═O)—NH—R₂—NCO can also generate a diurethane when the alcohol is in stoichiometric excess with respect to the diisocyanate.

Without wishing to be committed to any one theory, the Applicant Company assumes that the diurethane makes it possible to stabilize the thixotropic composition and to reduce the number of by-products obtained during its preparation. The presence of diurethane in the thixotropic composition makes it possible to eliminate or to greatly reduce the amount of salt, in particular of lithium salt, or of surfactant, with respect to the compositions of the prior art.

A diurethane compound can in particular correspond to a compound of formula (II):

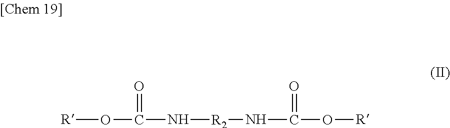

in which R′ and R₂ are as defined above for the compound of formula (I).

According to a specific embodiment, the thixotropic composition comprises from 20% to 95%, in particular from 25% to 85%, more particularly from 35% to 75%, in moles, of compound of formula (II), with respect to the total molar amount of compounds having one or more functional groups chosen from urea, urethane and their mixtures, aprotic solvent excepted.

### Polyurea-Diurethane Compound

The thixotropic composition according to the invention can additionally comprise a polyurea-diurethane compound. The thixotropic composition can comprise a mixture of polyurea-diurethane compounds.

The polyurea-diurethane compound can be a by-product resulting from the process for the preparation of the thixotropic composition according to the invention as described below. This is because the reaction between a monoisocyanate adduct of formula R′—O—C(═O)—NH—R₂—NCO and a diamine of formula H₂N—R₃—NH₂ can also generate a polyurea-diurethane when the reaction medium contains diisocyanate of formula OCN—R₂—NCO. The diisocyanate can in particular be residual diisocyanate originating from the reaction between a diisocyanate of formula OCN—R₂—NCO and an alcohol of formula R′—OH in order to form the monoisocyanate adduct of formula R′—O—C(═O)—NH—R₂—NCO.

A polyurea-diurethane compound can in particular correspond to a compound of formula (III):

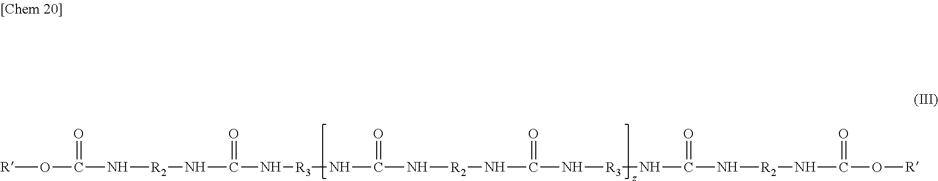

in which R′, R₂ and R₃ are as defined above for the compound of formula (I);
z is from 1 to 10.

As the polyurea-diurethane compounds are generally solids, it is advantageous to limit their amount in the thixotropic composition. Although it is possible to reduce the content of residual diisocyanate by carrying out a distillation stage before the reaction between the monoisocyanate adduct and the diamine, this represents a not insignificant cost and requires specific plants. The composition according to the invention exhibits a low content of polyurea-diurethane compound although its process of preparation does not require a stage of distillation of residual diisocyanate. This is rendered possible in particular by adjusting the molar ratio of the reactants employed in the process for the preparation of the thixotropic composition as described below.

According to a specific embodiment, the thixotropic composition comprises less than 4%, in particular from 3.0% to 1.5%, from 2.0% to 1.0%, or from 1.0% to 0%, in moles, of compound of formula (III), with respect to the total molar amount of compounds having one or more functional groups chosen from urea, urethane and their mixtures, aprotic solvent excepted.

### Process for the Preparation of the Thixotropic Composition

The thixotropic composition according to the invention can be prepared according to the process described below.

The preparation process according to the invention comprises a stage a), a stage b) and optionally one or more additional stages which can take place before stage a), between stage a) and stage b), and/or after stage b).

Stage a) is a stage during which at least one diisocyanate of formula OCN—R₂—NCO reacts with at least one alcohol of formula R′—OH in order to form at least one monoisocyanate adduct of formula R′—O—C(═O)—NH—R₂—NCO.

Stage b) is a stage during which the at least one monoisocyanate adduct obtained in stage a) reacts with at least one diamine of formula H₂N—R₃—NH₂ in order to form at least one compound of formula (I):

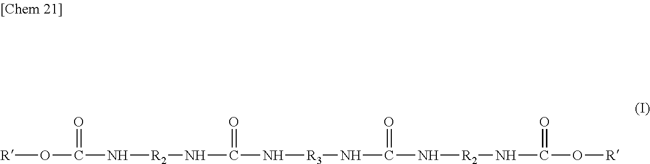

in which:
each R′ is independently chosen from alkyl, alkenyl, cycloalkyl, aryl, arylalkyl, •—[(CRₐR_{b})ₙ—O]ₘ—Y and •—[(CR_{c}R_{d})ₚ—C(═O)O]_{q}—Z;
the symbol • represents a point of attachment to a urethane group of the formula (I);
each R₂ is independently a divalent group chosen from an aliphatic group, a cycloaliphatic group, an aromatic group and an araliphatic group;
each R₃ is independently a divalent group chosen from an aliphatic group, a cycloaliphatic group, an aromatic group, an araliphatic group and a heterocyclic group;
Y and Z are independently chosen from alkyl, alkenyl, cycloalkyl, aryl and arylalkyl;
Rₐ, R_{b}, R_{c} and R_{d} are independently chosen from H and methyl, in particular H;
each n is independently equal to 2, 3 or 4, in particular n is 2;
m ranges from 1 to 30, in particular m ranges from 2 to 25;
p ranges from 3 to 5, in particular p is 5;
q ranges from 1 to 20, in particular q ranges from 2 to 10.

The R′, R₂ and R₃ groups, the diisocyanate of formula OCN—R₂—NCO, the alcohol of formula R′—OH and the diamine of formula H₂N—R₃—NH₂ can in particular be as defined above for the compound of formula (I). The specific embodiments described for the compound of formula (I) also apply to the process according to the invention.

Stage a) can in particular be carried out by gradually adding the at least one alcohol to a reactor containing the at least one diisocyanate. The at least one diisocyanate can in particular be in the molten state. The rate of addition of the at least one alcohol can be controlled in order to limit the exothermicity. In particular, the rate of addition of the at least one alcohol can be controlled in order to keep the temperature of the reaction medium less than or equal to 60° C., in particular from 20 to 60° C., from 25 to 55° C. or from 30 to 40° C.

Stage a) is carried out with a molar ratio of the total amount of alcohol to the total amount of diisocyanate of from 1.10 to 1.80. In particular, the molar ratio of the total amount of alcohol to the total amount of diisocyanate in stage a) ranges from 1.20 to 1.60, more particularly from 1.25 to 1.45, more particularly still from 1.30 to 1.40.

The ratio of alcohol with respect to the diisocyanate in stage a) makes it possible to limit the amount of residual diisocyanate at the end of stage a). The amount of residual diisocyanate at the end of stage a) corresponds to the amount of diisocyanate introduced in stage a) which has not reacted with the at least one alcohol. Controlling the amount of residual diisocyanate at the end of stage a) advantageously makes it possible to limit the formation of insoluble entities, in particular of compound of formula (III) as described above, during stage b). According to a specific embodiment, the amount of residual diisocyanate in the reaction mixture at the end of stage a) is less than 6 molar %, in particular from 0 molar % to 5 molar %, from 0.01 molar % to 4.5 molar % or from 0.05 molar % to 4 molar %, with respect to the molar amount of all of the compounds having one or more functional groups chosen from urethane, isocyanate and their mixtures.

The ratio of alcohol with respect to the diisocyanate in stage a) advantageously makes it possible to avoid the implementation of a stage of removal of residual diisocyanate. This is because the amount of residual diisocyanate at the end of stage a) is sufficiently low and will not generate an excessive formation of insoluble entities, in particular of compound of formula (III) as described above, during stage b). According to a specific embodiment, the process according to the invention does not comprise a stage of distillation of residual diisocyanate, in particular a stage of distillation of residual diisocyanate between stage a) and stage b).

The ratio of alcohol with respect to the diisocyanate in stage a) can result in the formation of one or more diurethane compound(s) as described above. A diurethane compound can in particular result from the reaction between an alcohol of formula R′—OH and the monoisocyanate adduct of formula R′—O—C(═O)—NH—R₂—NCO. Thus, the reaction mixture obtained in stage a) can comprise the monoisocyanate adduct of formula R′—O—C(═O)—NH—R₂—NCO and a compound of formula (II):

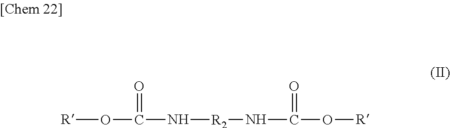

in which R′ and R₂ are as defined above.

Without wishing to be committed to any one theory, the Applicant Company assumes that the presence of diurethane compound in the thixotropic composition makes it possible to stabilize the urea bonds formed during stage b). Thus, it is possible to greatly reduce, indeed even to eliminate, the amount of stabilizer (in particular of salt, for example of lithium salt, or of surfactant) added in stage b), in comparison with the processes of the prior art.

Once the addition of the at least one alcohol is complete, stage a) can be continued until the NCO number of the reaction mixture reaches the theoretical NCO number. The NCO number at the end of stage a) can in particular be less than 200 mg KOH/g. In particular, the NCO number at the end of stage a) can be from 5 to 150 mg KOH/g, from 25 to 125 mg KOH/g, from 50 to 100 mg KOH/g or from 60 to 80 mg KOH/g. The NCO number at the end of stage a) can in particular be measured according to the method described below. The theoretical NCO number at the end of stage a) can in particular be calculated according to the method described below.

Stage b) can in particular be carried out by gradually adding the mixture obtained in stage a) to a reactor containing the at least one diamine and optionally aprotic solvent and/or salt. The rate of addition of the mixture obtained in stage a) can be controlled in order to limit the exothermicity. In particular, the rate of addition of the mixture obtained in stage a) can be controlled in order to keep the temperature of the reaction medium less than or equal to 80° C., in particular from 20 to 80° C., from 30 to 70° C. or from 40 to 60° C.

Once the addition of the at least one monoisocyanate adduct is complete, stage b) can be continued until the NCO number of the reaction mixture reaches the desired value. The NCO number of the composition obtained by the process of the invention can in particular be of less than 0.5 mg KOH/g, especially of less than 0.2 mg KOH/g, more particularly of less than 0.1 mg KOH/g, more particularly still 0 mg KOH/g. The NCO number of the composition can in particular be determined according to the method described below.

Stage b) is carried out in the presence of less than 0.2 mol of salt per mole of diamine used. In particular, stage b) is carried out in the presence of from 0 to 0.19, from 0 to 0.15, from 0 to 0.1, from 0 to 0.05, from 0 to 0.02, from 0 to 0.01 or 0 mol of salt per mole of diamine used. The salt can in particular be as defined above for the thixotropic composition.

Stage b) can be carried out in the presence of less than 0.2 mol of surfactant per mole of diamine used. In particular, stage b) is carried out in the presence of from 0 to 0.19, from 0 to 0.15, from 0 to 0.1, from 0 to 0.05, from 0 to 0.02, from 0 to 0.01 or 0 mol of surfactant per mole of diamine used. The surfactant can in particular be as defined above for the thixotropic composition.

The molar ratio of the total amount of monoisocyanate adduct to the total amount of diamine in stage b) can range from 1.8 to 2.2. In particular, the molar ratio of the total amount of monoisocyanate adduct to the total amount of diamine in stage b) ranges from 1.9 to 2.1, more particularly from 1.95 to 2.05, more particularly still from 1.98 to 2.02.

A solvent can be added in stage a) and/or in stage b) and/or between stage a) and stage b) in order to reduce the viscosity of the composition and to dissolve the compounds obtained. In particular, stage a) and/or stage b) can be carried out in the presence of an aprotic solvent. The viscosity of the reaction medium obtained at the end of stage a) can be lowered by adding aprotic solvent. The aprotic solvent can in particular be as defined above for the thixotropic composition.

The process according to the invention can be carried out using an alcohol or a mixture of alcohols in stage a).

According to a first embodiment, in stage a), the at least one diisocyanate reacts with a single alcohol of formula R₁—OH in order to form at least one monoisocyanate adduct of formula R₁—O—C(═O)—NH—R₂—NCO and,
in stage b), the product obtained in stage a) reacts with at least one diamine of formula H₂N—R₃—NH₂ in order to form at least one compound of formula (I′):

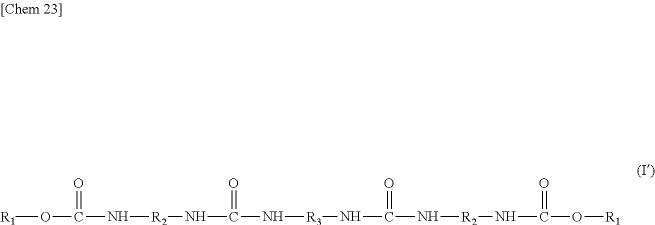

in which:
the R₁ groups are identical and as defined above for R′;
R₂ and R₃ are as defined above.

The alcohol R₁—OH of the first embodiment can in particular be a linear or branched C₁-C₃₀ alkyl substituted by OH.

According to a second embodiment, in stage a), the at least one diisocyanate reacts with at least two different alcohols of formulae R₄—OH and R₅—OH in order to form a mixture of at least two monoisocyanate adducts of formulae R₄—O—C(═O)—NH—R₂—NCO and R₅—O—C(═O)—NH—R₂—NCO and,
in stage b), the mixture obtained in stage a) reacts with at least one diamine of formula H₂N—R₃—NH₂ in order to form at least one compound of formula (Ia), optionally as a mixture with a compound of formula (Ib) and/or a compound of formula (Ic):

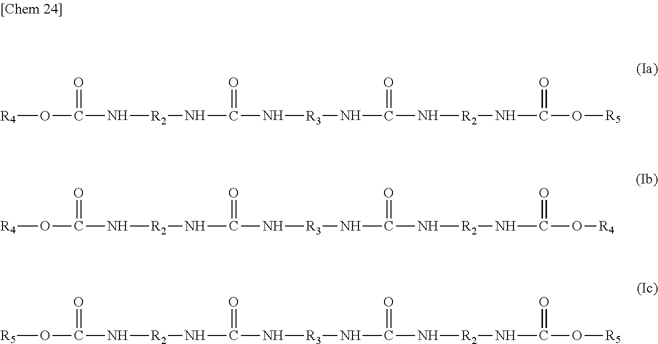

in which:
all the R₄ groups are identical and as defined above for R′;
all the R₅ groups are identical and as defined above for R′;
the R₄ groups are different from R₅.

The R₄ and R₅ groups, and also the alcohols of formulae R₄—OH and R₅—OH, can in particular be as defined above for the compound of formula (I).

In the second embodiment, the alcohol R₄—OH can be more hydrophobic than the alcohol R₅—OH; and/or the alcohol R₅—OH can have a higher molecular weight than that of the alcohol R₄—OH.

In the second embodiment, the molecular weights of the alcohols R₄—OH and R₅—OH can be different. In particular, R₄—OH can have a lower molecular weight than that of R₅—OH. More particularly, the difference between the molecular weight of R₄—OH and that of R₅—OH can be at least 50, at least 100, at least 150, at least 200, at least 300 or at least 350 g/mol.

In the second embodiment, the chemical natures of the alcohols R₄—OH and R₅—OH can be different. In particular, the alcohol R₄—OH can be more hydrophobic than the alcohol R₅—OH.

In the second embodiment, the alcohols R₄—OH and R₅—OH can be alcohols of formula HO—[(CRₐR_{b})ₙ—O]ₘ—Y having different molecular weights, Y, Rₐ, R_{b}, n and m being as defined above. Alternatively, the alcohol R₄—OH can be a linear or branched C₁-C₃₀ alkyl substituted by OH and the alcohol R₅—OH can be an alcohol of formula HO—[(CRₐR_{b})ₙ—O]ₘ—Y in which Y, Rₐ, R_{b}, n and m are as defined above.

In the second embodiment, the total molar amount of the alcohol R₅—OH, in particular of the least hydrophobic alcohol and/or of the alcohol having the highest molecular weight, can in particular represent more than 20%, especially from 25% to 95%, from 30% to 90%, from 35% to 85%, or from 40% to 80%, of the total molar amount of the alcohols R₄—OH and R₅—OH introduced in stage a).

In the second embodiment, the alcohol R₅—OH, in particular the least hydrophobic alcohol and/or the alcohol having the highest molecular weight, can in particular be reacted with the diisocyanate before the alcohol R₄—OH, in particular the most hydrophobic alcohol and/or the alcohol having the lowest molecular weight, is introduced into the reaction mixture of stage a).

According to a third embodiment, in stage a), the diisocyanate reacts with a mixture of at least three different alcohols of formulae R₄—OH, R₅—OH and R₆—OH in order to form a mixture of at least three monoisocyanate adducts of formulae R₄—O—C(═O)—NH—R₂—NCO, R₅—O—C(═O)—NH—R₂—NCO and R₆—O—C(═O)—NH—R₂—NCO and,
in stage b), the mixture obtained in stage a) reacts with at least one diamine of formula H₂N—R₃—NH₂ in order to form a compound of formula (Ia), a compound of formula (Id) and optionally one or more compounds of formula (Ib), (Ic), (Ie) or (If) represented below:

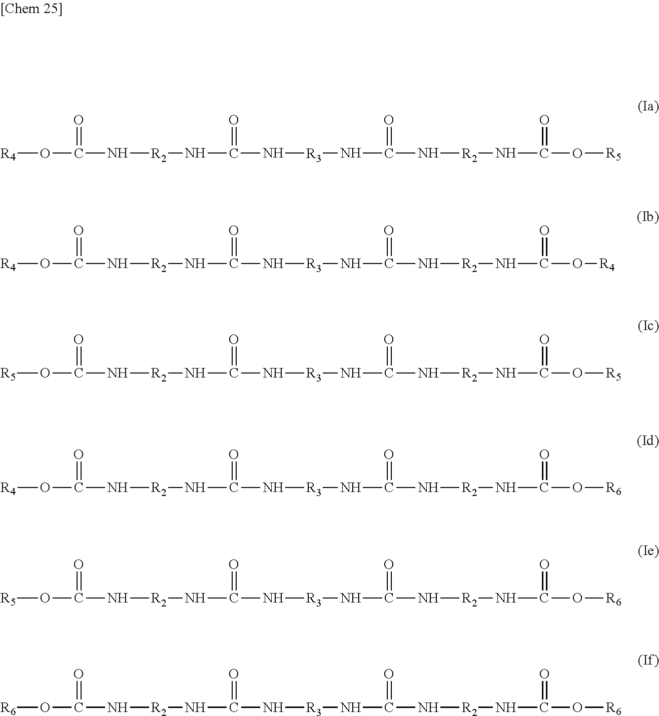

in which:
all the R₄ groups are identical and as defined above for R′;
all the R₅ groups are identical and as defined above for R′;
all the R₆ groups are identical and as defined above for R′;
the R₄ groups are different from R₅;
the R₄ groups are different from R₆;
the R₅ groups are different from R₆.

The R₄, R₅ and R₆ groups, and also the alcohols of formulae R₄—OH, R₅—OH and R₆—OH, can in particular be as defined above for the compound of formula (I).

In the third embodiment, the alcohol R₄—OH can be more hydrophobic than the alcohol R₅—OH and/or than the alcohol R₆—OH; and/or the alcohol R₄—OH can have a lower molecular weight than that of the alcohol R₅—OH and/or than that of the alcohol R₆—OH.

In the third embodiment, the molecular weights of the alcohols R₄—OH, R₅—OH and R₆—OH can be different. In particular, R₄—OH can have a lower molecular weight than that of R₅—OH; and/or R₄—OH can have a lower molecular weight than that of R₆—OH; and/or R₅—OH can have a lower molecular weight than that of R₆—OH. More particularly, the alcohol R₄—OH has a lower molecular weight than those of the alcohols R₅—OH and R₆—OH. More particularly still, the difference between the molecular weight of R₄—OH and that of R₅—OH; and/or the difference between the molecular weight of R₄—OH and that of R₆—OH; and/or the difference between the molecular weight of R₅—OH and that of R₆—OH can be at least 50, at least 100, at least 150, at least 200, at least 300 or at least 350 g/mol.

The alcohols R₄—OH, R₅—OH and R₆—OH can have different chemical natures. In particular, R₄—OH can be more hydrophobic than R₅—OH; and/or R₄—OH can be more hydrophobic than R₆—OH; and/or R₅—OH can be more hydrophobic than R₆—OH. More particularly, the alcohol R₄—OH is more hydrophobic than the alcohols R₅—OH and R₆—OH.

In the third embodiment, the alcohol R₄—OH can be a linear or branched C₁-C₃₀ alkyl substituted by OH and the alcohols R₅—OH and R₆—OH can be alcohols of formula HO—[(CRₐR_{b})ₙ—O]ₘ—Y having different molecular weights, Y, Rₐ, R_{b}, n and m being as defined above.

The total molar amount of the alcohols R₅—OH and R₆—OH, in particular the total molar amount of the least hydrophobic alcohols and/or of the alcohols having the highest molecular weights, can in particular represent more than 20%, especially from 25% to 95%, from 30% to 90%, from 35% to 85%, or from 40% to 80%, of the total molar amount of the alcohols R₄—OH, R₅—OH and R₆—OH introduced in stage a).

The alcohols R₅—OH and R₆—OH, in particular the least hydrophobic alcohols and/or the alcohols having the highest molecular weights, can in particular be reacted with the diisocyanate before the alcohol R₄—OH, in particular the most hydrophobic alcohol and/or the alcohol having the lowest molecular weight, is introduced into the reaction mixture of stage a).

### Binder Composition

The thixotropic composition according to the invention is advantageously introduced into a binder composition in order to modify its rheology, in particular in order to confer a thixotropic or pseudoplastic effect on it.

The binder composition according to the invention comprises a binder and the thixotropic composition as described above.

According to a specific embodiment, the binder composition is a coating composition, in particular a varnish, rendering, surface gel, paint or ink composition, an adhesive, glue or mastic composition, a moulding composition, a composite material composition, a chemical sealing composition, a leaktightness agent composition, a photocrosslinkable composition for stereolithography or for 3D printing of objects, in particular by inkjet printing.

The binder composition can in particular comprise from 0.5% to 15%, especially from 1% to 10%, more particularly from 2% to 7%, by weight of thixotropic composition, with respect to the weight of the binder composition.

The binder composition can in particular be an aqueous or solvent-based composition. Preferably, the binder composition is an aqueous composition.

According to a specific embodiment, the binder composition according to the invention is crosslinkable, either thermally and/or chemically (in particular by addition of a crosslinking agent, such as a peroxide, an epoxy resin, a melamine/formaldehyde resin, a blocked or unblocked polyisocyanate, an anhydride, an amine, a hydrazide, an aziridine or an alkoxysilane), or by irradiation under radiation, such as UV (in the presence of at least one photoinitiator) and/or EB (electron beam, without initiator), including self-crosslinkable at ambient temperature, or it is non-crosslinkable. The binder composition can be crosslinkable one-component (a single reactive component) or crosslinkable two-component (binder based on two components which react together by mixing during use).

The binder can be a binder commonly used in the field of coatings, varnishes and paints, such as those described in Ullmann's Encyclopedia of Industrial Chemistry, 5^{th} Edition, Vol. A18, pp. 368-426, VCH, Weinheim, 1991. According to a specific embodiment, the binder is chosen from a nitrocellulose, a cellulose ester (for example cellulose acetate or cellulose butyrate), a vinyl resin (for example a polyolefin, such as polyethylene or polyisobutylene, an olefin-based copolymer, such as an ethylene-vinyl acetate copolymer, or a modified polyolefin, such as a chlorinated or chlorosulfonylated polyethylene or polypropylene), a fluorinated polymer (for example polytetrafluoroethylene (PTFE), a tetrafluoroethylene-hexafluoropropylene (FEP) copolymer, an ethylene-tetrafluoroethylene (ETFE) copolymer, polyvinylidene fluoride (PVDF)), a polyvinyl ester (for example a polyvinyl acetate or a copolymer based on vinyl acetate), a polyvinyl alcohol, a polyvinyl acetal, a polyvinyl ether, an acrylic resin, an alkyd resin, an alkyd resin grafted by a polyester or a polyamide or diurea-diurethane modified, a saturated or unsaturated polyester resin, a polyurethane, a crosslinkable two-component polyurethane, an epoxy resin, a silicone resin, a polysiloxane, a phenolic resin, an epoxy-amine (crosslinkable two-component) reactive system, a polysulfide polymer, a (meth)acrylate polyfunctional oligomer or acrylated acrylic oligomer or allylic polyfunctional oligomer, an elastomer (for example SBR, polychloroprene or butyl rubber), a silanated prepolymer (for example a silanated polyether or a silanated polyurethane, or a silanated polyether-urethane) and their mixtures.

The binder can be an aqueous dispersion of polymer or copolymer particles, also known as latex. The polymers or copolymers can in particular be chosen from an acrylic, styrene/acrylic, vinyl acetate/acrylic or ethylene/vinyl acetate polymer or copolymer.

In a more specific case, the binder can be selected from the following crosslinkable two-component reactive systems: epoxy-amine or epoxy-polyamide systems comprising at least one epoxy resin comprising at least two epoxy groups and at least one amino or polyamide compound comprising at least two amine groups, polyurethane systems comprising at least one polyisocyanate and at least one polyol, polyol-melamine systems, and polyester systems based on at least one epoxy or on a polyol reactive with at least one acid or one corresponding anhydride.

According to other specific cases, the binder can be a crosslinkable two-component polyurethane system or a crosslinkable two-component polyester system starting from an epoxy-carboxylic acid or anhydride reaction system, or from a polyol-carboxylic acid or anhydride system, or a polyol-melamine reaction system in which the polyol is a hydroxylated acrylic resin, or a polyester or a polyether polyol.

In particular, the binder composition according to the invention is a two-component polyurethane composition based on a hydroxylated acrylic dispersion.

The binder composition according to the invention can comprise other components, such as, for example, fillers, plasticizers, wetting agents or also pigments.

### Use

The thixotropic composition according to the invention is used as rheology agent, in particular as thixotropic agent.

Thus, the incorporation of the thixotropic composition in a binder composition makes it possible to modify its rheology, in particular to confer a thixotropic effect on it.

By way of illustration of the invention, the following examples demonstrate, without any limitation, the performance qualities of the additive according to the present invention.

### EXAMPLES

### Measurement Methods

The measurement methods used in the present patent application are described below:

### NCO Number

The NCO number is measured by quantitative determination with a Metrohm (848 Titrino Plus) titrimeter equipped with a Metrohm reference 6.0229.100 measurement probe. The sample to be analysed is weighed into a 250 ml screw-necked Erlenmeyer flask. 50 ml de xylene—for stage a)—and 50 ml of DMSO—for stage b)—are added and the Erlenmeyer flask is hermetically closed. The sample is completely dissolved by magnetic stirring, if necessary while heating. If the dissolution of the sample has required heating, the mixture is left to return to ambient temperature before the following operation. 15 ml of 0.15N dibutylamine in xylene are added using a 15 ml precision pipette. The Erlenmeyer flask is hermetically stoppered and reaction is allowed to take place under gentle stirring for 15 minutes. 100 ml of isopropanol—in stage a)—and 100 ml of DMSO—in stage b)—are added while taking care to rinse the walls of the Erlenmeyer flask. Titration is carried out under magnetic stirring with 0.1N aqueous hydrochloric acid, according to the method of use of the chosen titrimeter. A blank quantitative determination (without sample) is carried out under the same conditions. The NCO number is calculated according to the following equation:

$${N}_{NCO} ( mg KOH / g ) = \frac{( VB - VS ) \times NT \times 56.1}{W} \qquad [ Math 1 ]$$

with
VS=Volume of titrant added for the quantitative determination of the sample (ml)
VB=Volume of titrant added for the quantitative determination of the blank (ml)
NT=Normality of the titrant (0.1N)
W=Weight of the sample (g).

### Theoretical NCO Number at the End of Stage a)

The theoretical NCO number at the end of stage a) is calculated according to the following equation:

$$Theoretical {N}_{NCO} ( mg KOH / g ) = \frac{( {w}_{isocyanate} \times {N}_{isocyanate} ) - ( {w}_{alcohols} \times {N}_{alcohols} )}{{w}_{total}}$$

### Brookfield® Viscosity

The viscosity was measured in accordance with Standard NF EN ISO 2555 June 2018 using a Brookfield® viscometer at 23° C. (spindle: S 5). A spindle of cylindrical shape rotates at a constant rotational speed around its axis in the product to be examined. The resistance which is exerted by the fluid on the spindle depends on the viscosity of the product. This resistance brings about torsion of the spiral spring, which is reflected in a viscosity value.

### Thixotropic Index

The thixotropic index was measured by dividing the viscosity obtained with the Brookfield® viscometer at 23° C. at the speed of 5 revolutions per minute by the viscosity obtained with this same viscometer at the speed of 50 revolutions per minute.

### Starting Materials

In the examples, the following starting materials were used:

TABLE 1

| Product used | Chemical name | Function | Supplier |
|---|---|---|---|
| Desmodur ® T 100 | Toluene-2,4-diisocyanate | Reactant | Covestro |
| Desmodur ® T 80 | Mixture of toluene-2,4-diisocyanate and | Reactant | Covestro |
| | toluene-2,6-diisocyanate with an 80:20 | | |
| | molar ratio | | |
| Polyglykol ® M 350 | Polyethylene glycol monomethyl ether | Reactant | Clariant |
| | (M = 330-370 g/mol) | | |
| Polyglykol ® M 500 | Polyethylene glycol monomethyl ether | Reactant | Clariant |
| | (M = 470-530 g/mol) | | |
| BTG | Butyl triglycol | Reactant | BASF |
| MXDA | meta-Xylylenediamine | Reactant | Itochu |
| DMSO | Dimethyl sulfoxide | Solvent | Arkema |
| LiCl | Lithium chloride | Stabilizer | FMC |
| Disperbyk ® 190 | Solution of high-molecular-weight | Dispersing | Byk- |
| | block copolymers | agent | Chemie |
| | having groups with a strong affinity | | |
| | for pigments | | |
| Byk ® 024 | Polypropylene glycol | Antifoaming | Byk- |
| | | agent | Chemie |
| TiO₂ Tiona | Titanium dioxide | Pigment | Cristal |
| RCL595 | | | |
| Encor ® 2171 | Aqueous acrylic copolymer dispersion | Resin | Arkema |
| Diethylene | Diethylene glycol butyl ether | Coalescent | VWR |
| glycol butyl | | agent | |
| ether | | | |
| Byk ® 333 | Polyether-modified | Spreading | Byk- |
| | dimethylpolysiloxane | agent | Chemie |

### Preparation of the Mixture of Alcohols

### Mixture A

411.76 g of MPEG 350 (1.177 mol) and 588.2 g of MPEG 500 (1.177 mol) were mixed in a 1 litre round-bottomed flask equipped with a thermometer and a stirrer at ambient temperature and under an inert atmosphere for 10 min, in order to give a clear liquid.

### Mixture B

189.2 g of MPEG 350 (0.54 mol) and 810.8 g of MPEG 500 (1.62 mol) were mixed in a 1 litre round-bottomed flask equipped with a thermometer and a stirrer at ambient temperature and under an inert atmosphere for 10 min, in order to give a clear liquid.

### Mixture C

120.8 g of BTG (0.59 mol) and 879.2 g of MPEG 500 (1.76 mol) were mixed in a 1 litre round-bottomed flask equipped with a thermometer and a stirrer at ambient temperature and under an inert atmosphere for 10 min, in order to give a clear liquid.

### Preparation of the Semi-Adducts

### Semi-Adduct A

145.3 g of Desmodur® T 100 (0.835 mol) were charged to a 500 ml reactor equipped with a thermometer, a condenser and a stirrer. 354.7 g of Mixture A (0.835 mol) were added via a dropping funnel over a period of time of 1 h while maintaining the temperature of the mixture below 40° C. At the end of the addition, the mixture was left stirring for 3 h and the NCO number was measured every hour until the theoretical NCO number of 93.6 mg KOH/g was reached.

### Semi-Adduct B

113.18 g of Desmodur® T 100 (0.65 mol) were charged to a 500 ml reactor equipped with a thermometer, a condenser and a stirrer. 386.82 g of Mixture A (0.91 mol) were added via a dropping funnel over a period of time of 1 h while maintaining the temperature of the mixture below 40° C. At the end of the addition, the mixture was left stirring for 3 h and the NCO number was measured every hour until the theoretical NCO number of 43.8 mg KOH/g was reached.

### Semi-Adduct C

105.95 g of Desmodur® T 100 (0.61 mol) were charged to a 500 ml reactor equipped with a thermometer, a condenser and a stirrer. 394.1 g of Mixture B (0.85 mol) were added via a dropping funnel over a period of time of 1 h while maintaining the temperature of the mixture below 40° C. At the end of the addition, the mixture was left stirring for 3 h and the NCO number was measured every hour until the theoretical NCO number of 41 mg KOH/g was reached.

### Semi-Adduct D

112.87 g of Desmodur® T 100 (0.65 mol) were charged to a 500 ml reactor equipped with a thermometer, a condenser and a stirrer. 387.13 g of Mixture C (0.91 mol) were added via a dropping funnel over a period of time of 1 h while maintaining the temperature of the mixture below 40° C. At the end of the addition, the mixture was left stirring for 3 h and the NCO number was measured every hour until the theoretical NCO number of 43.7 mg KOH/g was reached.

### Semi-Adduct E

98.76 g of Desmodur® T 100 (0.57 mol) and 14.1 g of Desmodur® T 80 (0.081 mol) were charged to a 500 ml reactor equipped with a thermometer, a condenser and a stirrer. 387.13 g of Mixture C (0.91 mol) were added via a dropping funnel over a period of time of 1 h while maintaining the temperature of the mixture below 40° C. At the end of the addition, the mixture was left stirring for 3 h and the NCO number was measured every hour until the theoretical NCO number of 43.7 mg KOH/g was reached.

### Semi-Adduct F

118.4 g of Desmodur® T 100 (0.68 mol) and 16.9 g of Desmodur® T 80 (0.1 mol) were charged to a 500 ml reactor equipped with a thermometer, a condenser and a stirrer. 364.7 g of Mixture C (0.86 mol) were added via a dropping funnel over a period of time of 1 h while maintaining the temperature of the mixture below 40° C. At the end of the addition, the mixture was left stirring for 3 h and the NCO number was measured every hour until the theoretical NCO number of 78.5 mg KOH/g was reached.

### Preparation of the Urea-Urethanes

### Example C1—Comparative

4.5 g of LiCl (0.106 mol) were dissolved in 300 g of DMSO (3.8 mol) and 19.25 g of MXDA (0.14 mol) at 80° C. in a 500 ml reactor equipped with a thermometer, a condenser and a stirrer. 176.25 g of semi-adduct A (0.28 mol) were subsequently added via a dropping funnel over a period of time of 1 h while maintaining the temperature of the mixture below 60° C. At the end of the addition, the mixture was left stirring for 30 minutes in order to give a clear liquid product at ambient temperature. The solids content of the mixture was 40%.

### Example 1—According to the Invention

53.96 mg of LiCl (1.27 mmol) were dissolved in 300 g of DMSO (3.8 mol) and 19.57 g of MXDA (0.144 mol) at 80° C. in a 500 ml reactor equipped with a thermometer, a condenser and a stirrer. 180.38 g of semi-adduct A (0.288 mol) were subsequently added via a dropping funnel over a period of time of 1 h while maintaining the temperature of the mixture below 60° C. At the end of the addition, the mixture was left stirring for 30 minutes in order to give a clear liquid product at ambient temperature. The solids content of the mixture was 40%.

### Example 2—According to the Invention

29.48 mg of LiCl (0.695 mmol) were dissolved in 300 g of DMSO (3.8 mol) and 10.69 g of MXDA (0.079 mol) at 80° C. in a 500 ml reactor equipped with a thermometer, a condenser and a stirrer. 189.28 g of semi-adduct B (0.157 mol) were subsequently added via a dropping funnel over a period of time of 1 h while maintaining the temperature of the mixture below 60° C. At the end of the addition, the mixture was left stirring for 30 minutes in order to give a clear liquid product at ambient temperature. The solids content of the mixture was 40%.

### Example 3—According to the Invention

11.39 mg of LiCl (0.269 mmol) were dissolved in 300 g of DMSO (3.8 mol) and 10.32 g of MXDA (0.076 mol) at 80° C. in a 500 ml reactor equipped with a thermometer, a condenser and a stirrer. 189.67 g of semi-adduct B (0.152 mol) were subsequently added via a dropping funnel over a period of time of 1 h while maintaining the temperature of the mixture below 60° C. At the end of the addition, the mixture was left stirring for 30 minutes in order to give a clear liquid product at ambient temperature. The solids content of the mixture was 40%.

### Example 4—According to the Invention

1.04 mg of LiCl (0.0245 mmol) were dissolved in 300 g of DMSO (3.8 mol) and 9.42 g of MXDA (0.07 mol) at 80° C. in a 500 ml reactor equipped with a thermometer, a condenser and a stirrer. 190.57 g of semi-adduct C (0.14 mol) were subsequently added via a dropping funnel over a period of time of 1 h while maintaining the temperature of the mixture below 60° C. At the end of the addition, the mixture was left stirring for 30 minutes in order to give a clear liquid product at ambient temperature. The solids content of the mixture was 40%.

### Example 5—According to the Invention

1.09 mg of LiCl (0.0257 mmol) were dissolved in 300 g of DMSO (3.8 mol) and 9.93 g of MXDA (0.075 mol) at 80° C. in a 500 ml reactor equipped with a thermometer, a condenser and a stirrer. 190.07 g of semi-adduct D (0.15 mol) were subsequently added via a dropping funnel over a period of time of 1 h while maintaining the temperature of the mixture below 60° C. At the end of the addition, the mixture was left stirring for 30 minutes in order to give a clear liquid product at ambient temperature. The solids content of the mixture was 40%.

### Example 6—According to the Invention

1.14 mg of LiCl (0.0269 mmol) were dissolved in 300 g of DMSO (3.8 mol) and 10.3 g of MXDA (0.076 mol) at 80° C. in a 500 ml reactor equipped with a thermometer, a condenser and a stirrer. 189.68 g of semi-adduct E (0.152 mol) were subsequently added via a dropping funnel over a period of time of 1 h while maintaining the temperature of the mixture below 60° C. At the end of the addition, the mixture was left stirring for 30 minutes in order to give a clear liquid product at ambient temperature. The solids content of the mixture was 40%.

### Example 7—According to the Invention

1.9 mg of LiCl (0.045 mmol) were dissolved in 300 g of DMSO (3.8 mol) and 17.28 g of MXDA (0.127 mol) at 80° C. in a 500 ml reactor equipped with a thermometer, a condenser and a stirrer. 182.72 g of semi-adduct F (0.254 mol) were subsequently added via a dropping funnel over a period of time of 1 h while maintaining the temperature of the mixture below 60° C. At the end of the addition, the mixture was left stirring for 30 minutes in order to give a clear liquid product at ambient temperature. The solids content of the mixture was 40%.

### Example 8—According to the Invention

112.5 g of DMSO (1.44 mol) and 3.91 g of MXDA (0.029 mol) were mixed in a 250 ml reactor equipped with a thermometer, a condenser and a stirrer. 71.09 g of semi-adduct D (0.058 mol) were subsequently added via a dropping funnel over a period of time of 1 h while maintaining the temperature of the mixture below 60° C. At the end of the addition, the mixture was left stirring for 30 minutes in order to give a clear liquid product at ambient temperature. The solids content of the mixture was 40%.

TABLE 2
Characteristics of the products

| | 2,4- | | | Molar | | | |
|---|---|---|---|---|---|---|---|
| | TDI | Alcohol | Alcohol | ratio | Molar ratio | | Molar ratio |
| Additive | (%)* | 1 (A1) | 2 (A2) | A1/A2 | Alcohols/TDI | Amine | LiCl/Amine |
| Example C1 | 100 | MPEG | MPEG | 1:1 | 1:1 | MXDA | 0.75 |
| (comparative) | | 350 | 500 | | | | |
| Example 1 | 100 | MPEG | MPEG | 1:1 | 1:1 | MXDA | 0.0088 |
| (invention) | | 350 | 500 | | | | |
| Example 2 | 100 | MPEG | MPEG | 1:1 | 1.4:1 | MXDA | 0.0088 |
| (invention) | | 350 | 500 | | | | |
| Example 3 | 100 | MPEG | MPEG | 1:1 | 1.4:1 | MXDA | 0.00035 |
| (invention) | | 350 | 500 | | | | |
| Example 4 | 100 | MPEG | MPEG | 1:3 | 1.4:1 | MXDA | 0.00035 |
| (invention) | | 350 | 500 | | | | |
| Example 5 | 100 | BTG | MPEG | 1:3 | 1.4:1 | MXDA | 0.00035 |
| (invention) | | | 500 | | | | |
| Example 6 | 97.5 | BTG | MPEG | 1:3 | 1.4:1 | MXDA | 0.00035 |
| (invention) | | | 500 | | | | |
| Example 7 | 97.5 | BTG | MPEG | 1:3 | 1.1:1 | MXDA | 0.00035 |
| (invention) | | | 500 | | | | |
| Example 8 | 100 | BTG | MPEG | 1:3 | 1.4:1 | MXDA | 0 |
| (invention) | | | 500 | | | | |

*the % of 2,4-TDI corresponds to the percentage by weight of toluene-2,4-diisocyanate, with respect to the total weight of the TDI isomers

TABLE 3
Appearance of the products

| Additive | Appearance | Stability |
|---|---|---|
| Example C1 (comparative) | Liquid | >12 months |
| Example 1 (invention) | Liquid | >12 months |
| Example 2 (invention) | Liquid | >12 months |
| Example 3 (invention) | Liquid | >12 months |
| Example 4 (invention) | Liquid | >12 months |
| Example 5 (invention) | Liquid | >12 months |
| Example 6 (invention) | Liquid | >12 months |
| Example 7 (invention) | Liquid | >12 months |
| Example 8 (invention) | Liquid | >12 months |

Despite the presence of a lower amount of salt than that indicated in the state of the art, indeed even the total absence of salt, the compositions according to the invention have an excellent stability over time.

### Applicative Tests

### Formulation F1

A paint formulation F1 was prepared with the following ingredients:

TABLE 4
Formulation F1

| | Component | Function | % by weight |
|---|---|---|---|
| Part A | Distilled water | Solvent | 5 |
| | Disperbyk 190 | Dispersing agent | 2.3 |
| | Byk ® 024 | Antifoaming agent | 0.1 |
| | TiO₂ Tiona RCL595 | Pigment | 22 |
| Part B | Encor 2171 | Resin | 66.4 |
| | Diethylene glycol butyl | Coalescent agent | 3.7 |
| | ether | | |
| | Byk ® 024 | Antifoaming agent | 0.25 |
| | Byk ® 333 | Spreading agent | 0.25 |

The formulation F1 of the water-based paint was prepared using a high-speed disperser (HSD). In a first stage, the part A was prepared by adding the various components and by dispersing at 2000 revolutions per minute for 15 minutes. Subsequently, the part B was prepared separately by adding the coalescent agent to the resin at a dispersion speed of 800 revolutions per minute and by continuing the dispersion at the same speed for 10 minutes. Subsequently, the part B was added to the part A, dispersing being carried out at 800 revolutions per minute for 10 minutes. Finally, the additives Byk® 024 and Byk® 333 were added and the formulation F1 was dispersed at 800 revolutions per minute for 10 minutes.

### Characterization of the Formulations

The additives of Comparative Example C1 and of Examples 1 to 7 according to the invention were evaluated in the formulation F1 by slowly adding 2.01 parts of rheology additive at a dispersion speed of 800 revolutions per minute to 200 grams of this paint F1. Subsequently, the mixture was dispersed at 1300 revolutions per minute for 3 minutes with a dispersion blade with a diameter of 3.5 cm. The mixture obtained was stored at 23° C.+/−1° C. for 24 h before measuring the rheological properties, without the mixture being homogenized before the measurements.

TABLE 5
Applicative results

| | Viscosity, Brookfield ® RV2+, 23° C. (mPa · s) | | | | |
|---|---|---|---|---|---|
| | 1 | 5 | 10 | 50 | Thixotropic |
| Additive used | rev/min | rev/min | rev/min | rev/min | index 5/50 |
| Example C1 (comparative) | 9200 | 3800 | 2420 | 980 | 3.9 |
| Example 1 (invention) | 15 600 | 4840 | 2840 | 1132 | 4.3 |
| Example 2 (invention) | 10 600 | 4120 | 2400 | 1130 | 3.6 |
| Example 3 (invention) | 10 800 | 4960 | 2800 | 1212 | 4.1 |
| Example 4 (invention) | 8400 | 3200 | 2240 | 1032 | 3.1 |
| Example 5 (invention) | 12 400 | 4440 | 2600 | 1140 | 3.9 |
| Example 6 (invention) | 11 800 | 6280 | 3240 | 1490 | 4.2 |
| Example 7 (invention) | 17 600 | 5720 | 3480 | 1344 | 4.3 |

The paint formulations containing the rheology additives according to the invention show rheological performance qualities which are equivalent to, indeed even superior to, those of the additives of the state of the art.

1. A thixotropic composition comprising a compound of formula (I) or a mixture of compounds of formula (I) and an aprotic solvent: 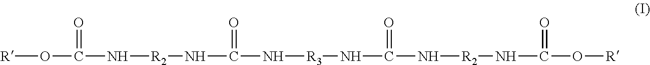
in which:
each R′ is independently selected from the group consisting of alkyl, alkenyl, cycloalkyl, aryl, arylalkyl, •—[(CRₐR_{b})ₙ—O]ₘ—Y and •—[(CR_{c}R_{d})ₚ—C(═O)O]_{q}—Z;
the symbol • represents a point of attachment to a urethane group of the formula (I);
each R₂ is independently a divalent group selected from the group consisting of an aliphatic group, a cycloaliphatic group, an aromatic group and an araliphatic group;
each R₃ is independently a divalent group selected from the group consisting of an aliphatic group, a cycloaliphatic group, an aromatic group, an araliphatic group and a heterocyclic group;
Y and Z are independently selected from the group consisting of alkyl, alkenyl, cycloalkyl, aryl and arylalkyl;
Rₐ, R_{b}, R_{c} and R_{d} are independently selected from the group consisting of H and methyl;
each n is independently equal to 2, 3 or 4;
m ranges from 1 to 30;
p ranges from 3 to 5;
q ranges from 1 to 20;
wherein the composition contains less than 0.1 mol of salt per urea group in the composition, aprotic solvent excluded.

2. The thixotropic composition according to claim 1, wherein the composition contains from 0 to 0.09 mol, or from 0 to 0.07 mol, or from 0 to 0.05 mol, or from 0 to 0.03 mol, or from 0 to 0.01 mol, or from 0 to 0.01 mol, of salt per urea group in the composition, aprotic solvent excluded.

3. The thixotropic composition according to claim 1 wherein the salt is selected from the group consisting of a metal salt, an ionic liquid and an ammonium salt.

4. The thixotropic composition according to claim 1 wherein the composition contains less than 0.1 mol of surfactant per urea group in the composition.

5. (canceled)

6. The thixotropic composition according to claim 1 wherein the composition comprises from 5% to 80%, in moles, of compound of formula (I), with respect to the total molar amount of compounds having one or more functional groups selected from the group consisting of urea, urethane and their mixtures, aprotic solvent excluded.

7. The thixotropic composition according to claim 1 wherein the composition additionally comprises at least one compound of formula (II): 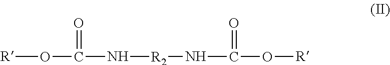
in which:
R′ and R₂ are as defined in claim 1.

8. The thixotropic composition according to claim 7, wherein the composition comprises from 20% to 95%, in moles, of compound of formula (II), with respect to the total molar amount of compounds having one or more functional groups selected from the group consisting of urea, urethane and their mixtures, aprotic solvent excluded.

9. (canceled)

10. (canceled)

11. The thixotropic composition according to claim 10, wherein the R′ groups are identical and correspond to R₁; R₁ being a linear or branched C₁-C₃₀ alkyl.

12. The thixotropic composition according to claim 1 wherein the composition comprises a mixture of compounds of formula (I), said mixture containing at least one compound of formula (I) in which the R′ groups are different.

13. (canceled)

14. (canceled)

15. The thixotropic composition according to claim 1 wherein the mixture of compounds of formula (I) contains at least two different compounds of formula (I) in which the R′ groups are different.

16. (canceled)

17. (canceled)

18. The thixotropic composition according to claim 1 wherein more than 20 mol % of all of the R′ groups contained in the compound(s) of formula (I) are hydrophilic group.

19. The thixotropic composition according to claim 1 wherein each R₂ is independently an aromatic group.

20. The thixotropic composition according to claim 1 wherein more than 85 mol % of all of the R₂ groups contained in the compound(s) of formula (I) are aromatic groups of the following formula: 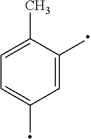
in which the symbol • represents a point of attachment to a urea or urethane group of the formula (I).

21. The thixotropic composition according to claim 1 wherein each R₃ is independently a group selected from a group consisting of C₂-C₂₄ alkylene, —(CRₕRᵢ)ₛ-[A-(CRⱼRₖ)ₜ]ᵤ—, —(CRₗRₘ)ᵥ—CY—(CRₙRₒ)_{w}— and —(CRₚR_{q})ₓ—CY—(CH₂)_{y}—CY—(CRᵣRₛ)_{z}—;
in which:
A is O or NX;
Rₕ, Rᵢ, Rⱼ, Rₖ, Rₗ, Rₘ, Rₙ, Rₒ, Rₚ, R_{q}, Rᵣ and Rₛ are independently chosen from H and methyl;
X is a C₁ to C₆ alkyl;
CY is a ring chosen from phenyl, cyclohexyl, naphthyl, decahydronaphthyl, piperazinyl, triazinyl and pyridinyl, the ring being unsubstituted or substituted by 1 to 3 C₁-C₄ alkyl groups;
s ranges from 2 to 4;
t ranges from 2 to 4;
u ranges from 1 to 30;
v, w, x, y and z independently range from 0 to 4.

22. The thixotropic composition according to claim 1 wherein each R₃ is independently a group selected from the group consisting of C₂-C₂₄ alkylene and —(CRₗRₘ)ᵥ—CY—(CRₙRₒ)_{w}—with CY a cyclohexyl or phenyl ring, the ring being unsubstituted or substituted by 1 to 3 C₁-C₄ alkyl groups, v and w ranging from 0 to 1.

23. (canceled)

24. (canceled)

25. A process for the preparation of a thixotropic composition, comprising the following stages:
a) reacting at least one diisocyanate of formula OCN—R₂—NCO with at least one alcohol of formula R′—OH in order to form at least one monoisocyanate adduct of formula R′—O—C(═O)—NH—R₂—NCO, the molar ratio of the total amount of alcohol to the total amount of diisocyanate ranging from 1.10 to 1.80;
b) reacting the at least one monoisocyanate adduct obtained in stage a) with at least one diamine of formula H₂N—R₃—NH₂ in the presence of less than 0.2 mol of metal salt per mole of diamine used, in order to form at least one compound of formula (I) 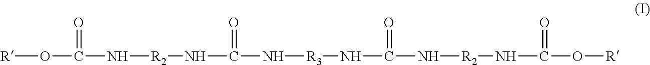
in which:
each R′ is independently selected from the group consisting of alkyl, alkenyl, cycloalkyl, aryl, arylalkyl, •—[(CRₐR_{b})ₙ—O]ₘ—Y and •—[(CR_{c}R_{d})ₚ—C(═O)O]_{q}—Z;
the symbol • represents a point of attachment to a urethane group of the formula (I):
each R₂ is independently a divalent group selected from the group consisting of an aliphatic group, a cycloaliphatic group, an aromatic group and an araliphatic group:
each R₃ is independently a divalent group selected from the group consisting of an aliphatic group, a cycloaliphatic group, an aromatic group, an araliphatic group and a heterocyclic group:
Y and Z are independently selected from the group consisting of alkyl, alkenyl, cycloalkyl, aryl and arylalkyl;
Rₐ, R_{b}, R_{c} and R_{d} are independently selected from the group consisting of H and methyl:
each n is independently equal to 2, 3 or 4:
m ranges from 1 to 30:
p ranges from 3 to 5:
q ranges from 1 to 20.

26. The process according to claim 25, wherein stage b) is carried out in the presence of from 0 to 0.19, from 0 to 0.15, from 0 to 0.1, from 0 to 0.05, from 0 to 0.02, from 0 to 0.01 or 0 mol of salt per mole of diamine used.

27. The process according to claim 25 wherein stage b) is carried out in the presence of less than 0.2 of surfactant per mole of diamine used.

28. The process according to claim 25 wherein it does not comprise a stage of distillation of residual diisocyanate.

29. The process according to claim 25 wherein the amount of residual diisocyanate in the reaction mixture at the end of stage a) is less than 6 molar %, with respect to the molar amount of all of the compounds having one or more functional groups chosen from urethane and isocyanate.

30. (canceled)

31. The process according to claim 25 wherein:
in stage a), the at least one diisocyanate reacts with a single alcohol of formula R₁—OH in order to form at least one monoisocyanate adduct of formula R₁—O—C(═O)—NH—R₂—NCO and,
in stage b), the product obtained in stage a) reacts with at least one diamine of formula H₂N—R₃—NH₂ in order to form at least one compound of formula (I′): 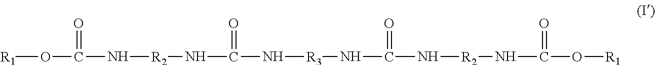
in which:
the R₁ groups are identical and as defined for R′ in claim 25;
R₂ and R₃ are as defined in claim 25.

32. The process according to claim 25 wherein:
in stage a), the at least one diisocyanate reacts with at least two different alcohols of formulae R₄—OH and R₅—OH in order to form a mixture of at least two monoisocyanate adducts of formulae R₄—O—C(═O)—NH—R₂—NCO and R₅—O—C(═O)—NH—R₂—NCO and,
in stage b), the mixture obtained in stage a) reacts with at least one diamine of formula H₂N—R₃—NH₂ in order to form at least one compound of formula (Ia), optionally as a mixture with a compound of formula (Ib) and/or a compound of formula (Ic): 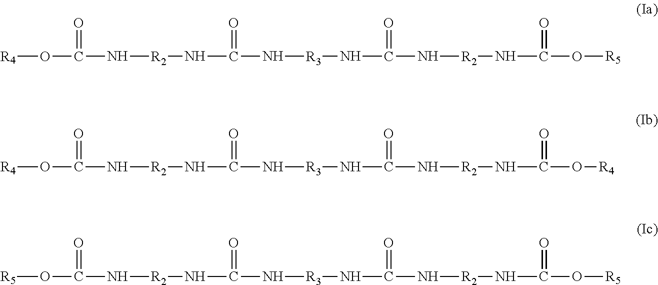
in which:
all the R₄ groups are identical and as defined for R′ in claim 25;
all the R₅ groups are identical and as defined for R′ in claim 25;
the R₄ groups are different from R₅.

33. (canceled)

34. (canceled)

35. (canceled)

36. The process according to claim 25 wherein:
in stage a), the diisocyanate reacts with a mixture of at least three different alcohols of formulae R₄—OH, R₅—OH and R₆—OH in order to form a mixture of at least three monoisocyanate adducts of formulae R₄—O—C(═O)—NH—R₂—NCO, R₅—O—C(═O)—NH—R₂—NCO and R₆—O—C(═O)—NH—R₂—NCO, and,
in stage b), the mixture obtained in stage a) reacts with at least one diamine of formula H₂N—R₃—NH₂ in order to form a compound of formula (Ia), a compound of formula (Id) and optionally one or more compounds of formula (Ib), (Ic), (Ie) or (If) represented below: 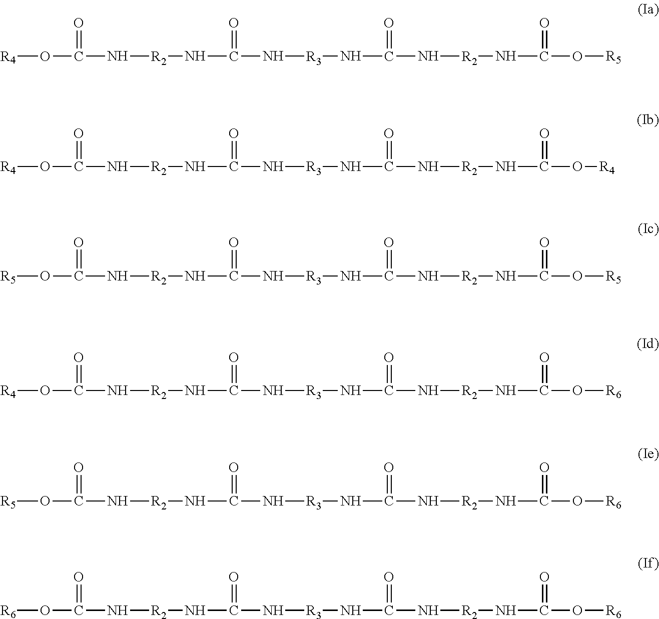
in which:
all the R₄ groups are identical and as defined for R′ in claim 25;
all the R₅ groups are identical and as defined for R′ in claim 25;
all the R₆ groups are identical and as defined for R′ in claim 25;
the R₄ groups are different from R₅;
the R₄ groups are different from R₆;
the R₅ groups are different from R₆.

37. (canceled)

38. (canceled)

39. (canceled)

40. A binder composition comprising a binder and the thixotropic composition according to claim 1.

41. (canceled)

42. (canceled)
